(19) United States
(12) Patent Application Publication
(10) Pub. No.: US 2011/0246483 A1
(43) Pub. Date: Oct. 6, 2011

(54) Pattern Detection and Recommendation

(75) Inventors: Timothy P. Darr, Austin, TX (US); Sherry Marcus, Austin, TX (US)

(73) Assignee: 21ST CENTURY TECHNOLOGIES, INC., Austin, TX (US)

(21) Appl. No.: 12/960,762

(22) Filed: Dec. 6, 2010

Related U.S. Application Data
(63) Continuation-in-part of application No. 11/673,816, filed on Feb. 12, 2007, now Pat. No. 7,856,411.
(60) Provisional application No. 60/784,438, filed on Mar. 21, 2006.

(51) Int. Cl. G06F 17/30

(52) U.S. Cl. 707/748; 707/E17.005; 707/E17.044

(57) ABSTRACT

In one or more embodiments, one or more methods and/or systems described can perform receiving a pattern; determining that components of the received pattern match corresponding components of patterns that have not been rated by a user but have been rated by other users in the user's community; calculating multiple predictive ratings corresponding to the patterns; ranking the patterns based on the predictive ratings; and recommending one or more of the top-ranked patterns to the user. In one or more embodiments, calculating multiple predictive ratings corresponding to the patterns can include calculating multiple correlation coefficients. In one example, calculating multiple correlation coefficients can be based on the other users' ratings of the patterns. In another example, calculating multiple correlation coefficients can be based on the other users' ratings of one or more components of the patterns.

### PRIORITY CLAIM

This application is a continuation-in-part of and claims priority to U.S. patent application Ser. No. 11/673,438, filed Feb. 12, 2007, which claims benefit of priority to U.S. Provisional Application No. 60/784,438, filed on Mar. 21, 2006. Each of U.S. patent application Ser. No. 11/673,438 and U.S. Provisional Application No. 60/784,438 is hereby incorporated by reference in its entirety.

### RELATED APPLICATIONS

The present application is related to the following co-pending U.S. patent applications: U.S. patent application Ser. No. 11/367,944 filed on Mar. 4, 2006; U.S. patent application Ser. No. 11/367,943 filed on Mar. 4, 2006; U.S. patent application Ser. No. 11/539,436 filed on Mar. 20, 2006; and U.S. patent application Ser. No. 11/557,584 filed on Apr. 21, 2006. Relevant content of the related applications are incorporated herein by reference.

### BACKGROUND

1. Technical Field

This disclosure relates generally to evaluation of patterns associated with computer networks and social networks. More particularly, this disclosure relates to a method, system and computer program product for computer-implemented pattern recommendation and analysis within computer networks and social networks.

2. Description of the Related Art

Social Network Analysis (SNA) is a technique utilized by anthropologists, psychologists, intelligence analysts, and others to analyze social interaction(s) and/or to investigate the organization of and relationships within formal and informal networks such as corporations, filial groups, or computer networks.

SNA typically represents a social network as a graph (referred to as a social interaction graph, communication graph, activity graph, or sociogram). In its simplest form, a social network graph contains nodes representing actors (generally people or organizations) and edges representing relationships or communications between the actors. In contrast with databases and spreadsheets, which tend to facilitate reasoning over the characteristics of individual actors, graph-based representations facilitate reasoning over relationships between actors.

In conventional analysis of these graphs most users search and reason over the graphs visually, and the users are able to reason about either the individual actors or the network as a whole through graph-theoretic approaches. SNA was developed to describe visual concepts and truths between the observed relationships/interactions. In conventional social network analysis, most graphs are analyzed by visual search and reasoning over the graphs. Analysts are able to reason about either individual actors or the network as a whole through various approaches and theories about structure, such as the small-worlds conjecture. Thus, SNA describes visual concepts and truths between the observed relationships and actors.

Analysts use certain key terms or characterizations to refer to how actors appear to behave in a social network, such as gatekeeper, leader, and follower. Designating actors as one of these can be done by straightforward visual analysis for static (i.e., non-time varying graphs of past activity). However, some characterizations can only be made by observing a graph as the graph changes over time. This type of observation is significantly harder to do manually.

Thus, SNA metrics were developed to distill certain aspects of a graph's structure into numbers that can be computed automatically. Metrics can be computed automatically and repetitively for automated inspection. Decision algorithms, such as neural networks or hidden Markov models may then make the determination if a given actor fills a specific role. These algorithms may be taught to make the distinction with labeled training data.

### BRIEF DESCRIPTION OF THE DRAWINGS

The embodiments will become apparent upon reading the following detailed description and upon reference to the accompanying drawings in which:

FIG. 1 is a block diagram representation of a data processing system, according to one or more embodiments;

FIG. 2 is a pictorial representation of an example input graph depicting an example social network interaction that can be analyzed, according to one or more embodiments;

FIG. 3 illustrates an example graph pattern, representing specific interactions that are of interest to potential users, according to one or more embodiments;

FIG. 4 illustrates an example matching of the graph pattern of FIG. 3 with the input graph of FIG. 2, according to one or more embodiments;

FIG. 5 illustrates paths of communication between a matched pattern and a node (or person) of interest within the larger input graph of FIG. 2, according to one or more embodiments;

FIG. 6 illustrates the result when a primary or relevant intermediate node is eliminated from a communication link between the matched pattern and the node of interest, according to one or more embodiments;

FIG. 7 illustrates different method of identifying a central node within an input graph, according to one or more embodiments;

FIG. 8 illustrates the resulting, separated activity graphs produced following removal of the relevant intermediate node, according to one or more embodiments;

FIG. 9 illustrates the application of context to a graph pattern to determine conditions of interests, according to one or more embodiments;

FIG. 10 is a flow chart illustrating a process for identifying social communications of interest (i.e., given particular, pre-established contexts) utilizing an input graph of a social network to match a pattern graph, according to one or more embodiments;

FIG. 11 is a flow chart illustrating the process for detecting matched patterns and calculating associated scores for the matched patterns detected, according to one or more embodiments;

FIG. 12 illustrates an exemplary graphical user interface that can display multiple patterns, according to one or more embodiments;

FIG. 13 illustrates exemplary recommended patterns, according to one or more embodiments;

FIG. 14 illustrates exemplary data sources that can be used in combination with a pattern, according to one or more embodiments;

FIG. 15A illustrates a high-level flow diagram of a ratings table, a collaborative utility, predictions, and recommendations, according to one or more embodiments;

FIG. 15B illustrates a high-level flow diagram of a ratings table, pattern data, a pattern component table, a component ratings table, a collaborative utility, predictions, and recommendations, according to one or more embodiments;

FIG. 16 illustrates a method of recommending patterns, according to one or more embodiments;

FIG. 17 illustrates a method of calculating a predictive rating for an active user and an item, according to one or more embodiments;

FIGS. 18A and 18B illustrate a method of calculating a correlation coefficient, according to one or more embodiments;

FIGS. 19A and 19B illustrate a method of calculating a correlation coefficient, according to one or more embodiments;

FIGS. 19C and 19D illustrate a method of calculating a correlation coefficient utilizing component ratings, according to one or more embodiments;

FIG. 20 illustrates a method of calculating a correlation coefficient, according to one or more embodiments;

FIG. 21 illustrates a method of calculating an Euclidean distance, according to one or more embodiments; and

FIGS. 22 and 23 illustrate equations that can be calculated by one or more methods and/or processes described herein, according to one or more embodiments.

### DETAILED DESCRIPTION

In one or more embodiments, one or more methods and/or systems described can perform receiving multiple vectors corresponding to multiple users, where each vector of the multiple vectors includes multiple ratings corresponding to multiple patterns; calculating, based on a vector of the multiple vectors corresponding to a user of the multiple users and the multiple vectors, multiple correlation coefficients; calculating, based on the multiple correlation coefficients, multiple predictive ratings corresponding to the multiple patterns; and ranking the multiple patterns based on the multiple predictive ratings. In one example, the multiple patterns can include multiple graph patterns. In one instance, social network interaction data is provided as an input graph including nodes and edges. In another instance, computer network interaction data and/or computer network event data is provided as an input graph including nodes and edges. In one or more embodiments, a graph illustrates the connections and/or interactions between people, objects, events, and matches them to a context. A sample graph pattern of interest can be identified and/or defined by the user of an application that implements one or more methods and/or systems described herein. With this sample graph pattern and the input graph, a computational analysis can be performed.

In one embodiment, the context may be a preset number of degrees of separation between one node in the detected graph and another node/point of interest within the overall social network. In another embodiment, a particular social role (e.g., gatekeeper) may be defined for one of the participants within the social network based on the connection of person, events, activities, etc. to the node representing that individual. Also, a social network analysis (SNA) and graph pattern matching performed on the input graph can utilize pre-defined SNA metrics.

In one or more embodiments, Social Network Aware Pattern Detection (SNAP) can apply to any graph-pattern matching algorithm or process where the objective is to find sub-patterns within a graph. The methodology enhances the sub-graph isomorphism problem (SGISO), which is described in F. Harary's Graph Theory, Addison-Wesley, 1971, incorporated herein by reference. SNAP (i.e., the SNAP utility) can rank retrieved graph matched patterns using SNA-based techniques. SNAP provides a framework for integrating group detection, SNA and graph pattern matching, through an SNA-based ranking of retrieved graph patterns, where the criteria for matching an entity include SNA metrics, roles or features. In one or more embodiments, a metric can be an attribute of a node in a graph, or a subgraph within the graph. Furthermore, a social network role can be a node in the graph that plays a prominent and/or distinguishing role in the graph, such as a gatekeeper. Group detection mechanisms/methodologies can include the Best Friends (BF) and Auto Best Friends (Auto BF) Group Detection methodologies, which are described in related U.S. patent application Ser. No. 11/557,584.

In one or more embodiments, SNAP can include one or more of: (1) Integration of SNA metrics into graph pattern matching; (2) Integration of SNA metric intervals to constrain the search; and (3) Integration of other SNA constructs, such as groups, into graph pattern matching, among others. With the integration of SNA metrics into graph pattern matching, any existing or future SNA metric can be incorporated into a graph matching algorithm when determining if a node in the graph matches a node in the pattern. The pattern match criteria can specify a predicate defined over SNA metric values. Examples of SNA metrics supported include one or more of: average cycle length, average path length, centrality measures, circumference, clique measures, clustering measures, degree, density, diameter, girth, number of nodes, radius, and radiality, among others. Descriptions of this listing of SNA metrics as well as other possible SNA metrics that may be utilized within one or more embodiments described herein are provided in Wasserman, S. & Faust, K.'s Social Network Analysis: Methods and Applications (Structural Analysis in the Social Sciences), Cambridge University Press, 1994. Relevant content of that reference is incorporated herein by reference. The actual group of SNA metrics utilized may vary depending on implementation.

The description is presented with multiple sections and subsections, delineated by corresponding headings and subheadings. The headings and subheadings are intended to improve the flow and structure of the description, but do not provide any limitations on the description or embodiments. The content (i.e., features described) within any one section may be extended into other sections. Further, functional features provided within specific sections may be practiced individually or in combination with other features provided within other sections.

More specifically, labeled Section A provides a structural layout for an example data processing system, which may be utilized to perform the SNAP analysis functions described herein. Labeled Section B describes software-implemented features of a SNAP utility, a collaboration utility, and provides an example social network graph (also referred to as the input graph), along with a description of SNA and SNA metrics, which enhance the operation of SNAP utility. Labeled Section C describes integrating SNA roles into pattern matching. Labeled Section D describes inexact SNA metric calculations. Labeled Section E describes recommending or predicting one or more patterns for a user.

### A. Data Processing System as Snap Device

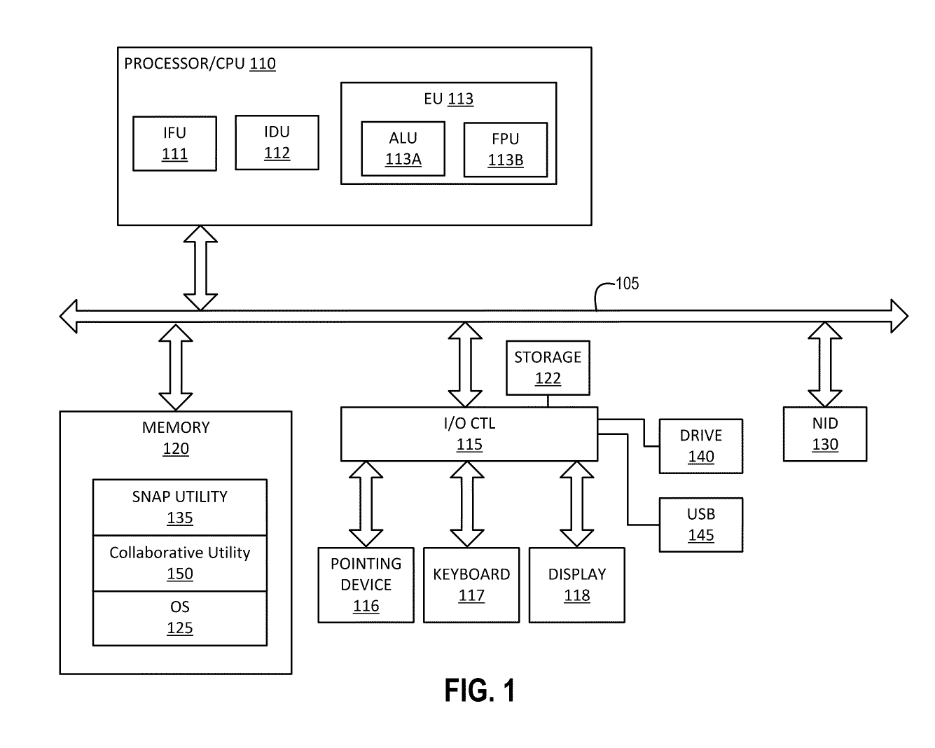

One or more embodiments can be provided via a processing device which includes a mechanism for receiving the SNA data and for analyzing the data according to the methodology described hereinafter. In one embodiment, a SNA pattern detection device, referred to hereinafter as a SNAP device, is provided and can include one or more hardware and software components that enable dynamic SNAP detection and analysis, based on (1) received data/information from the social network, (2) pre-defined and/or newly defined SNAP metrics, and/or (3) other user-provided inputs. As further illustrated within FIG. 1 and described below, the SNAP device can be a data processing system, which executes a SNAP utility that completes the specific SNAP detection and analysis functions described below. In one embodiment, as described in details in section B below, SNAP device receives an input social network graph generated via one of (a) an enhanced GMIDS (eGMIDs) process, which is described within co-pending U.S. patent application Ser. No. 11/367,943. The described eGMIDS methodology can be utilized. Regardless of the source, the input graph provides the social network dataset and/or a graph representation of the SNAP dataset from the general network. In another embodiment, the user provides the input social network graph via some input means of the SNAP device. Actual network-connectivity of the SNAP device is not a requirement for one or more implementations.

Referring now to FIG. 1, there is depicted a block diagram representation of a data processing system that can be utilized as the SNAP device, according to one or more embodiments. As shown, data processing system (DPS) 100 includes one or more processors or central processing units such as central processing unit (CPU) 110 coupled to memory 120 via system interconnect/bus 105. Also coupled to system bus 105 is I/O controller 115, which provides connectivity and control for input devices, pointing device (or mouse) 116 and keyboard 117, and output device, display 118. Additionally, a multimedia drive 140 (e.g., CDRW or DVD drive) and USB (universal serial bus) port 145 are illustrated, coupled to I/O controller. Drive 140 and USB port 145 can operate as both input and output mechanisms. As shown, DPS 100 can include storage 122, within which data utilized to provide the input graph and the pattern graph (described below) can be stored.

As illustrated, CPU 110 can include one or more of an instruction fetch unit (IFU) 111, an instruction decode unit (IDU) 112, and an execution unit (EU) 113 that includes an arithmetic logic unit (ALU) 113A and a floating-point unit (FPU) 113B. In one or more embodiments, IFU 111 can fetch instructions (e.g., SNAP utility 135, collaborative utility 150, OS 125, etc.) from memory 120, and IDU 112 can decode the instructions and configure EU 113 to process data according to the instructions. In one or more embodiments, IFU 111 can fetch instructions (e.g., SNAP utility 135, collaborative utility 150, OS 125, etc.) from memory 120 via one or more caches (not shown).

In one example, IDU 112 can configure ALU 113A to perform one of various arithmetic operations. In one instance, the one of various arithmetic operations that can be performed by ALU 113A can include one or more fixed point mathematic operations such as one or more of add, subtract, multiply, divide, and modulus, among others, that can be used to calculate results from input data. In another instance, the one of various arithmetic operations that can be performed by ALU 113A can include logical operations such as one or more of OR, XOR, AND, NAND, NOR, and NOT, among others, that can be used to calculate results from input data. In another example, IDU 112 can configure FPU 113B to perform one of various floating-point mathematical operations such as one or more of add, subtract, multiply, and divide, among others, that can be used to calculate results from input data. In one or more embodiments, EU 113 can include multiple arithmetic logic units (ALUs) and/or multiple floating-point units (FPUs) that can be used in performing superscalar operations.

DPS 100 is also illustrated with a network interface device (NID) 130 with which DPS 100 can couple to another computer device or computer network (e.g., a local area network, a wide area network, a public switched telephone network, an Internet, etc.). NID 130 can include a modem and/or a network adapter, for example, depending on the type of network and coupling method to the network. One or more processes described herein can occur within a DPS 100 that is not coupled to an external network. For example, DPS 100 can receive input data (e.g., input social network graph, input ratings table, etc.) via some other input means, such as a CD/DVD medium within multimedia input drive 140, a thumb drive inserted in USB port 145, user input via keyboard 117, or other input device.

Those of ordinary skill in the art will appreciate that the hardware depicted in FIG. 1 is a basic illustration of a data processing system and may vary. Thus, the depicted example is not meant to imply architectural limitations.

### B. Snap Utility, Collaborative Utility, Social Network and Pattern Graphs, SNA Metrics

Notably, in addition to the above described hardware components of DPS 100, one or more embodiments can be provided as software code stored within memory 120 or other storage (not shown) and executed by CPU 110. Thus, located within memory 120 and executed on CPU 110 are a number of software components, including operating system (OS) 125 (e.g., Microsoft Windows®, a trademark of Microsoft Corp, or GNU®/Linux®, registered trademarks of the Free Software Foundation and The Linux Mark Institute) and software applications, of which SNAP utility 135 and collaborative utility 150 are shown.

In one or more embodiments, SNAP utility 135 can be loaded onto and executed by any existing computer system to provide the dynamic pattern detection and analysis features within any input social network graph, as further described below. For example, CPU 110 can execute SNAP utility 135 as well as OS 125, which supports the execution of SNAP utility 135. In one or more embodiments, one or more graphical user interfaces (GUIs) and/or other user interfaces can be provided by SNAP utility 135 and can be supported by the OS 125 to enable user interaction with, or manipulation of, the parameters utilized during processing by SNAP utility 135.

Among the software code/logic provided by SNAP utility 135, according to one or more embodiments, are (a) code for enabling the SNA target graph detection, and (b) code for matching known target graphs to an input graph; (b) code for displaying a SNAP console and enabling user setup, interaction and/or manipulation of the SNAP processing; and (c) code for generating and displaying the output of the SNAP analysis in user-understandable format. In one or more embodiments, the collective body of code that enables these various features is referred to herein as SNAP utility 135. In one or more embodiments, when CPU 110 executes OS 125 and SNAP utility 135, DPS 100 initiates a series of functional processes, that enable the above functional processes as well as corresponding SNAP features/functionality described below.

In one or more embodiments, SNAP utility 135 processes data represented as a graph, where relationships among nodes are known and provided. For example, SNAP utility 135 can perform the various SNAP analyses (relationships among interconnected nodes) through use of an input graph representation. The input graph representation provides an ideal methodology because edges define the relationships between two nodes. Relational databases can also be utilized, in other embodiments. In an example graph showing a set of individuals, nodes represent various entities including one or more of people, organizations, objects, and events, among others. For instance, edges link nodes in the graph and represent relationships, such as interactions, ownership, and trust. Attributes can store the details of each node and edge, such as a person's name or an interaction's time of occurrence.

In one embodiment, a social network can be utilized to loosely refer to a collection of communicating/interacting persons, devices, entities, businesses, and the like within a definable social environment (e.g., familial, local, national, and/or global). Within this environment, a single entity/person can have social connections (directly and indirectly) to multiple other entities/persons within the social network, which can be represented as a series of interconnected data points/nodes within an activity graph (also referred to herein as an input social network graph 200). Generation of an example activity graph is the subject of the co-pending U.S. application patent Ser. No. 11/367,944, and a description of features relevant to basic social network analysis is provided in co-pending U.S. application patent Ser. No. 11/557,584. Thus, the social network described, according to one or more embodiments, can also be represented as a complex collection of interconnected data points within a graph.

In one or more embodiments, collaborative utility 150 can be loaded onto and executed by any existing computer system to provide ranking of multiple patterns based on multiple predictive ratings of patterns and/or computer network events, as further described below. For example, CPU 110 can execute collaborative utility 150 as well as OS 125, which supports the execution of collaborative utility 150. In one or more embodiments, one or more GUIs and/or other user interfaces can be provided by collaborative utility 150 and can be supported by the OS 125 to enable user interaction with, or manipulation of, the parameters utilized during processing by collaborative utility 150.

Among the software code/logic provided by collaborative utility 150, according to one or more embodiments, are (a) code for receiving multiple vectors corresponding to multiple users, where each vector of the multiple vectors includes multiple ratings corresponding to multiple patterns; (b) code for calculating, based on a vector of the multiple vectors corresponding to a user of the multiple users and the multiple vectors, multiple correlation coefficients; (c) code for calculating, based on the multiple correlation coefficients, multiple predictive ratings corresponding to the multiple patterns; and (d) code for ranking the multiple patterns based on the multiple predictive ratings.

In one or more embodiments, the code for ranking the multiple patterns based on the multiple predictive ratings can include code for sorting the multiple predictive ratings from a high predictive rating of the multiple predictive ratings to a low predictive rating of the multiple predictive ratings and ordering the multiple patterns based on the multiple predictive ratings sorted from the high predictive rating to the low predictive rating. In one or more embodiments, the collective body of code that enables these various features is referred to herein as collaborative utility 150. In one or more embodiments, when CPU 110 executes OS 125 and collaborative utility 150, DPS 100 initiates a series of functional processes, that enable the above functional processes as well as corresponding collaborative utility and/or collaborative filtering features/functionality described below.

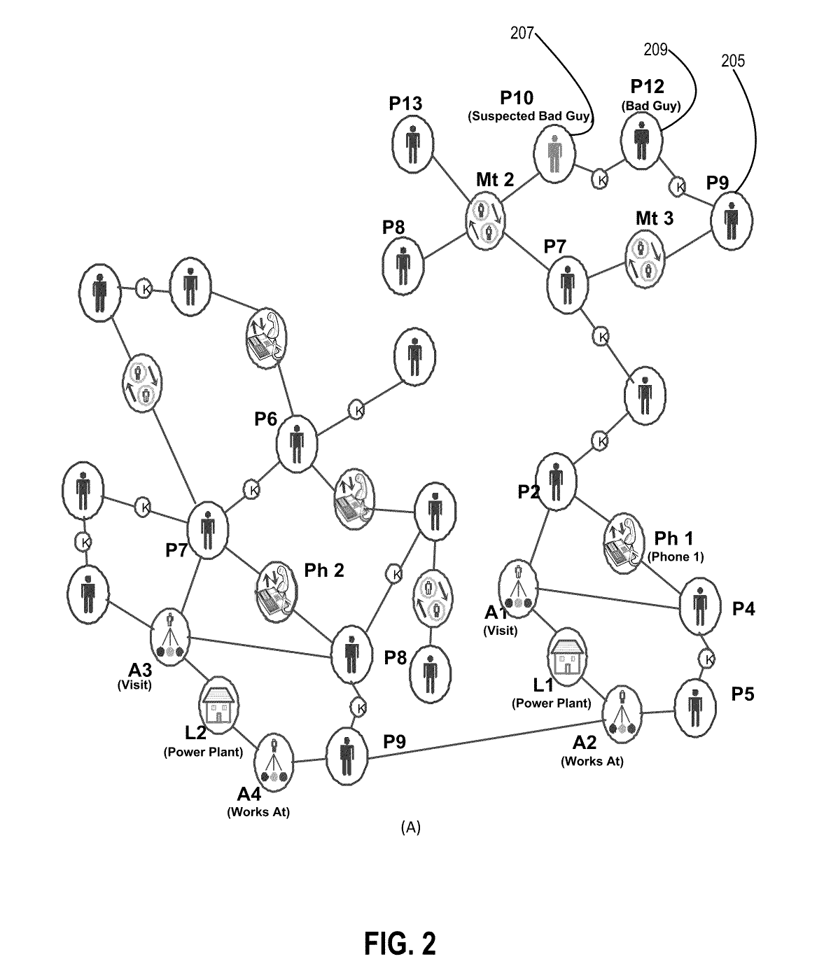

FIG. 2 illustrates an exemplary social network, according to one or more embodiments. In one or more embodiments, social network 200 can be a person-to-person communication and/or interaction network, represented as a graph of nodes connected via edges. As illustrated, each node is represented as an oblong-shaped object with the edges identified as lines connecting the various nodes. In some instances, the interconnection between two nodes involves an intermediary communication device, such as a telephone. Additionally, communication between two nodes can be established via some action of one of the adjoining nodes (persons), such as a visit to a facility.

Within the illustrated graph of social network 200, the nodes represent can an identifiable person, object, or thing that communicates, interacts, or supports some other form of activity with another node. Edges connecting each node can represent contact with or some other connection/interaction between the two connected nodes. In one or more embodiments, the edges are weighted to describe how well or how frequent the two nodes interact (e.g., how well the two persons represented as nodes actually know each other, how frequent their contact is, etc.). This weighing of the edges can be used as a factor when analyzing the social network for “events of interest,” described in greater details below.

As illustrated social network 200 can include multiple persons, including example person 205, interacting and/or communicating with each other. These persons (205) can interact via a number of different communication means, including via personal exchange 210, K 215 (which represents “knowledge of” or “acquaintance of” or “knows” the connected node), and telephone 220. Additionally, other activities of one or more persons (205) are recorded within social network 200, including activities related to several facilities 225 (illustrated as power plants, in this example). Thus, social network 200 can provide an indication of visits 230 to these facilities 225 as well as whether a person (205) is a worker 235 (i.e., works at) one of these facilities 225. In one or more embodiments, a facility 225 can include a power plant, a military base, a business, a ship, a data center, or a telecommunications center, among others.

In addition to the multiple persons 205 generally represented within social network 200, social network can also provides two “persons of interests,” identified as Suspected BadGuy 207 and BadGuy 209. These persons of interests can be connected, directly or indirectly, to the remaining nodes (persons, facilities, etc) within social network 200 via one or more of the communication/interaction means (person-to-person communication 210, telephone 220, etc.).

In one or more embodiments, social network 200 is predominantly a person-to-person network. It is understood that the method of communication from one person to another may vary and that some electronic communication mechanism (cell phone, computer, etc.) can be utilized in such communications. Thus, another illustration of the network can encompass the physical devices utilize to complete the various communications. In one or more embodiments, the entities in the social network (or corresponding graph) do not have to be people. For example, the entities represented can be organizations, countries, groups, animals, etc. Regardless of the type of entities, one or more features can be fully applicable so long as the entities are configured in some form of a social network or include characteristics of a social network.

In one or more embodiments, one or more SNA metric intervals can be utilized to constrain a search within the pattern match predicate, and the use of intervals to constrain or focus the search can be supported. One additional feature can include an integration of other SNA constructs, such as groups, into graph pattern matching. With integration of SNA constructs, in addition to the use of SNA metrics to define the match criteria, one or more methods described can allow for group membership. Also, a match predicate can require that the node be a member of a group with certain characteristics. Specification of the group can also include the definition of certain SNA or graph metrics, as defined above.

In one or more embodiments, the SNAP system can augment existing graph matching algorithms and/or processes to include an ability to match nodes against certain SNA roles and positions, such as entities with high centrality measures, communication gateways, cut-outs, and reach-ability to other particular entities of interest, among others. This augmentation of graph matching can enhance an ability of a user (who may be an analyst or casual user, for example) to filter out irrelevant or benign matches in a computationally efficient way.

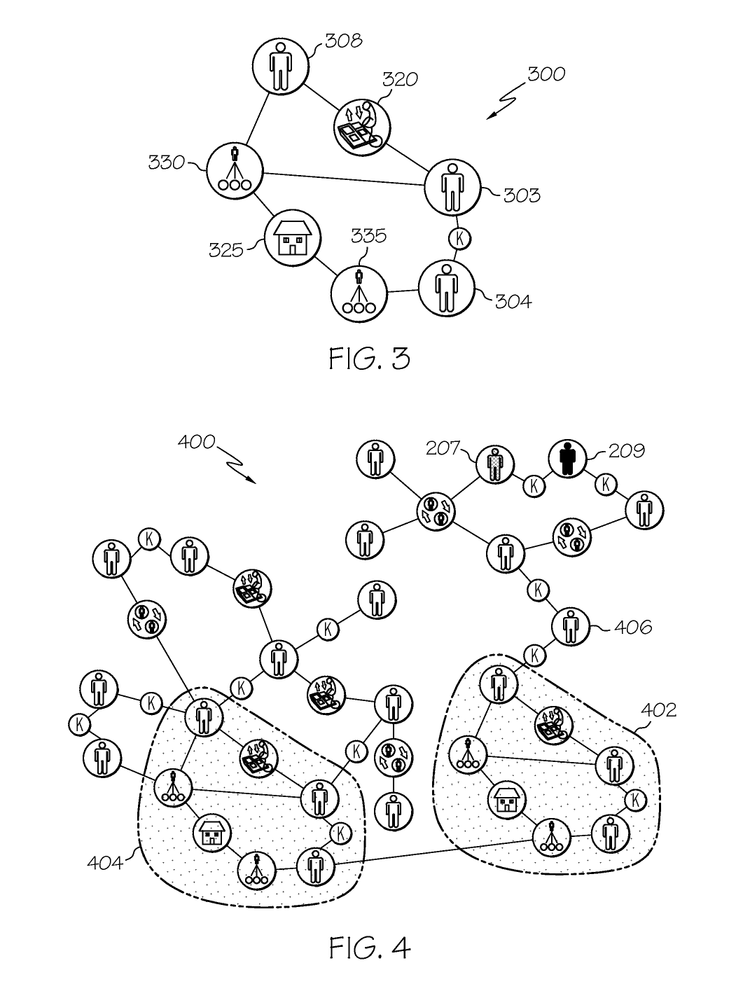

An example of the approach is provided with reference to FIGS. 3 and 4. According to the example, SNAP is being utilized to identify individuals within a social network 300 in which one member (or node) is connected to a target facility 325 (e.g., a power plant) and in which the network or individuals therein can be targeting the facility for an some malicious undertaking (breach of security protocol, theft, damage to property, disruption of operations, etc.). With this example, suspicious individual 308 (i.e., a person of interest to the user) has arranged a visit 330 to the target facility 325 via an indirect relationship (phone communication 320) with someone (insider 304) that has an association 335 with (e.g., works in/at) the facility 325. With this description of the possible threat or activity of interest, the pattern graph of FIG. 3 can be generated and maintained (e.g., stored) within the evaluation device (DPS 100) for use in analyzing an input graph.

As shown, insider 304, who has an association 335 with target facility 325, communicates directly with an intermediary 303, who in turn communicates with suspicious person 308 via telephone communication 320. Suspicious person arranges a visit 330 to the target facility 325. Once a chain is completed, the pattern can be established as one that can be of interest to a user. The exact order of the various interactions/communication may not be a factor in completing the pattern graph; however, once the SNAP utility initiates its evaluation, the order can be utilized to provide some (contextual) weight in the analysis of matched patterns.

In the illustrated pattern, “Suspicious Person” 308 represents a person that might have malicious intentions (e.g., a known trouble maker or someone with a known grudge against the power plant). “Insider” 304 is the person that has some kind of “Association” 335 with the facility (“Target”) 325 and can arrange visits 330. This person may be a worker at the facility 325, for example. “Intermediary” 303 knows both the “Insider” 304 and the “Suspicious Person” 308. In one or more embodiments, the “Insider” 304 may not know the possible harmful motives/intentions of “Suspicious Person” 308. As far as “Insider” 304 knows, “Suspicious Person” 308 is a “friend of a friend” (i.e., intermediary 303). “Suspicious Person” 308 and “Intermediary” 303 are in communication 320 with one another. With this information, SNAP utility can be utilized to determine or determine with a percentage of certainty who is the “bad guy” within input graph 400 (FIG. 4). SNAP utility also rates the level of concern (with respect to the possible threat from the bad guy) on a scale (e.g., from 1-10), using graph matching and enhanced SNA techniques.

Thus, according to the described and illustrative embodiments, the notion of a “bad guy” may not be a binary assessment (e.g., yes or no); rather, the level of “badness”, the “threat level”, or the degree or percentage of certainty can depend on the associations that an entity has, or the social network of which the entity is a member, evaluated within the context of those interactions. For example, a person might be a threat because he is a member of a domestic drug network. For instance, the person might also be a threat because he is a member of a gang. An FBI analyst may be likely to consider the member of the domestic drug network more of a threat than a military analyst, while the military analyst may be likely to consider the member of the terrorist cell the bigger threat. The key point is that the degree of threat level for an entity can depend entirely on the context and can range from a minimal threat to a severe threat. In one or more embodiments, SNAP can allow for rankings based on social network context.

To determine who the “bad guy” is or might be, the user would work with a dataset represented as a graph, an example of which is shown in FIG. 4. As shown, input graph 400 can include people, actions, communication events and locations. Using input graph 400, a user is unable, with current technology, to distinguish a threatening visit to the facility from a benign visit. FIG. 4 illustrates two matches for the pattern 300, one benign match 404 and one threatening match 402, using graph matching techniques. For the visit to be threatening, the visitor (P2, P7) have some association with one or both of “suspected bad guy” 207 or “bad guy” 209. The visit may also be benign, such as a worker taking a friend for a tour of the plant. A distinguishing feature in this input dataset between the benign pattern match 404 and the threatening pattern match 402 can be the indirect relationships between the visitor (P2) and potential “bad guys” (207, 209). Using the SNAP utility, such characteristics can be automatically identified from each of these patterns. The utility then can rank the pattern matches based on these characteristics, in real time, as an automated service to the user.

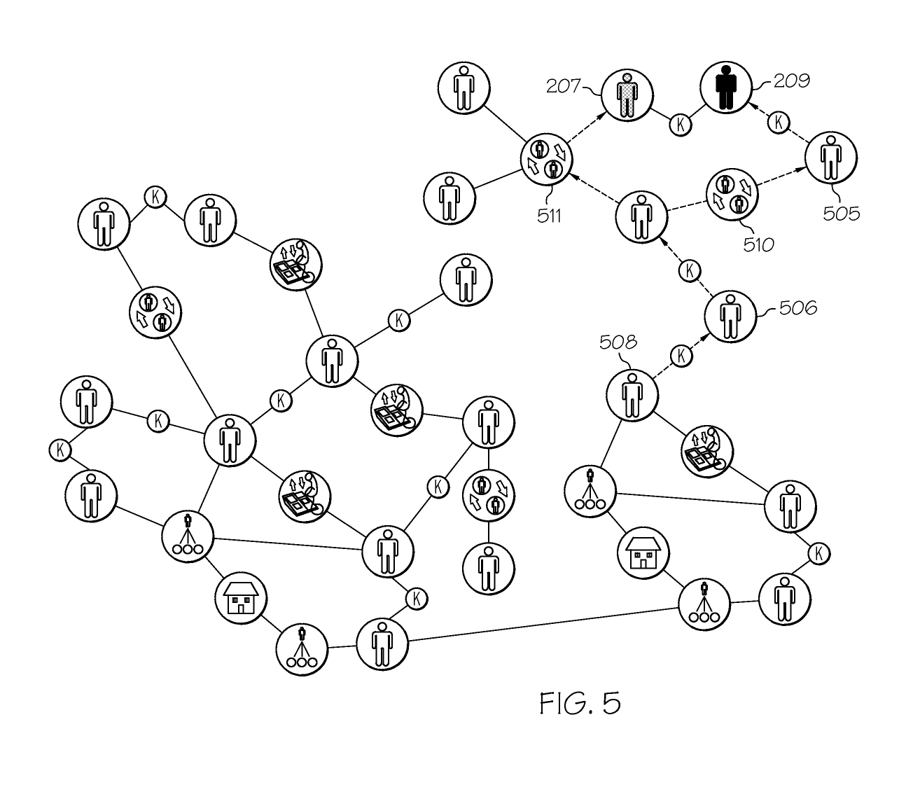

In one or more embodiments, two methods of SNA-based pattern matching can provide an ability to support the user (or analyst). First, using SNAP, the user can be provided an ability to add the criteria (or take the criteria from an SNA library) that the visitor (P2) is within a certain path length to a known “bad guy” (207). This method provides an SNA metric that can be calculated at the time the matched pattern is detected in order to rule out the benign pattern match 404 from the possibly threatening pattern match 402. The second method can involve using SNAP to rank the detected matches in order to identify which matches are worth a second look by the user (or analyst). FIG. 5 shows that there are two communication paths from visitor “P2” to “bad guy” 209 or “suspected bad guy” 207 within input graph 500. Representing this relationship in a pattern using current technology can be complex for two reasons: (1) it can overcomplicate the pattern, as there would be more nodes and edges required, and (2) there may be way with conventional implementation to be able to dynamically specify the number of links from the visitor (P2) to the “bad guy” 209.

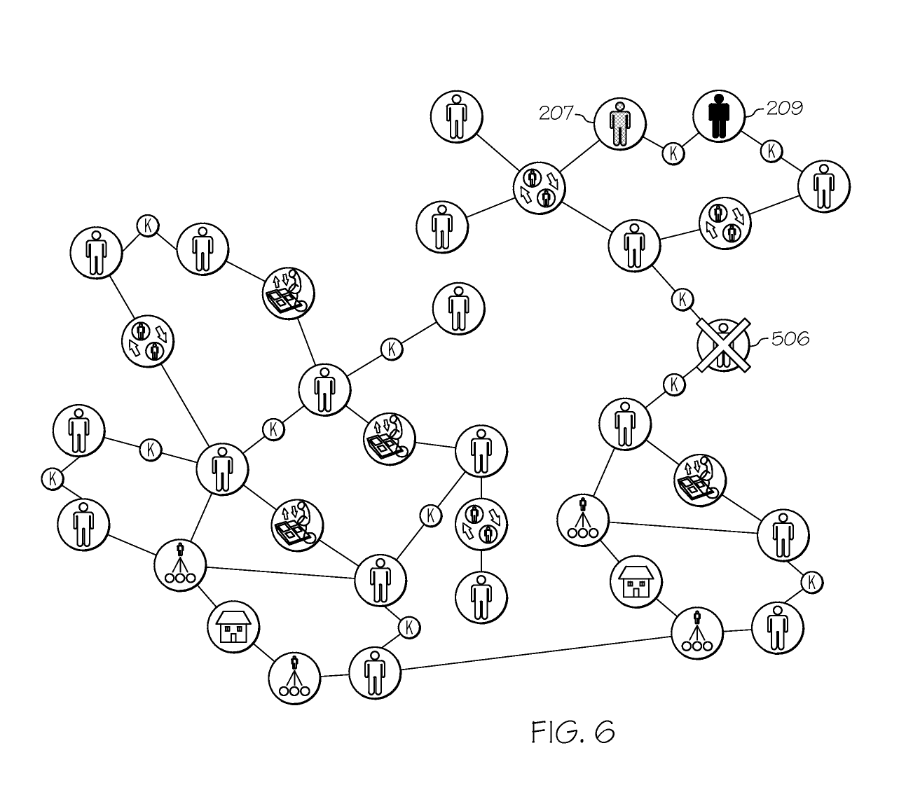

In one or more embodiments, as shown by FIG. 6, the user is able to specify that the intermediary 506 be a “cut-out.” This type of analysis (role) is key in social network analysis as the individual that fulfills the intermediary role is critical in bridging the communication between two groups or between a node of interest and a matched group. FIG. 6 shows the network with the cutout node marked with an “X”. In one or more embodiments, an ability to further qualify the possible matches using SNA metrics and techniques adds a powerful mechanism to filter out the possibly benign matches, which can distract a user from focusing attention on the real threats.

FIG. 8 then shows a resulting network. In one or more embodiments, the user is able to quickly identify that if the intermediary 506 is removed, then the “bad guy” network 801 is separated from the benign network 802, as shown by FIGS. 6 and 8, which shows the separated, smaller networks after the cutout node (506) is identified and removed.

C. Integrating SNA Roles into Pattern Matching

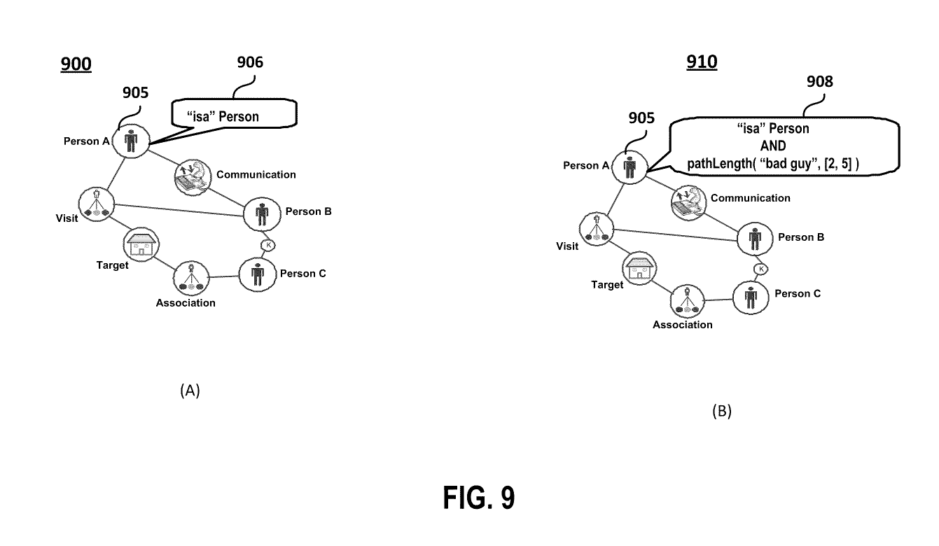

FIG. 9 illustrates an aspect of the basic framework for integrating SNA capability into graph matching algorithms, compared with the conventional graph matching technique, according to one or more embodiments. Specifically, FIG. 9 shows a before (conventional implementation of pattern graph description) and after (new implementation of pattern graph description) notional representation of how pattern matches can be specified. As shown by pattern graph A 900 of FIG. 9, the conventional pattern match specifications for “Person A” 905 are that the node “isa Person” (906). Then, the only allowed specifications are predicates over the attributes of the node. In this example, the match specification is defined local to the node.

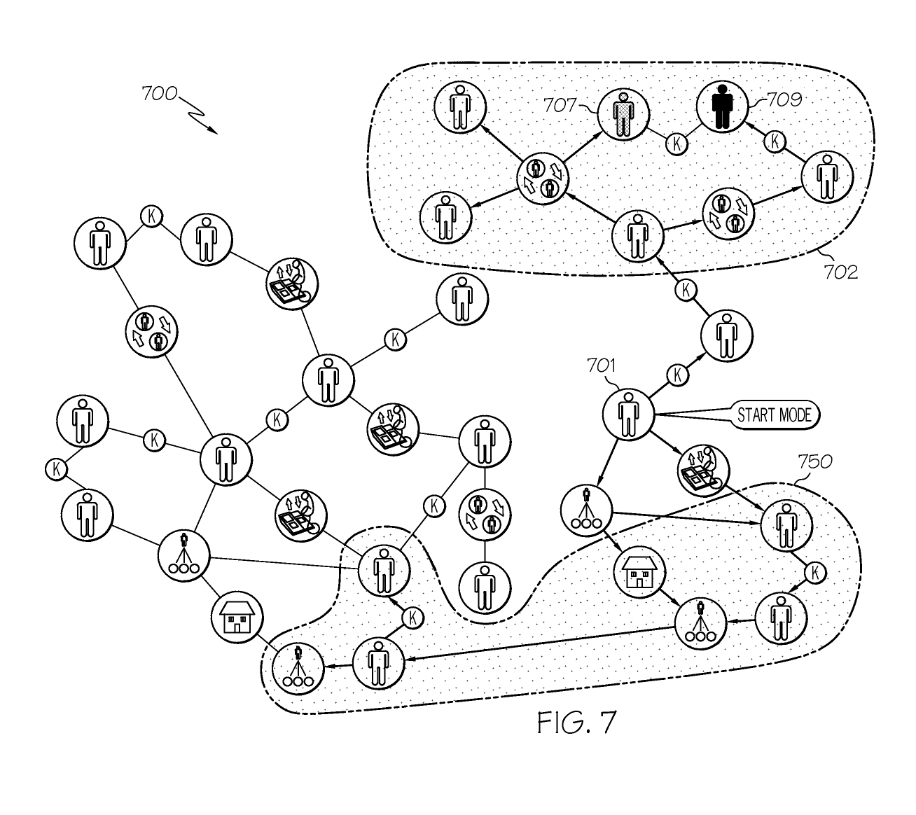

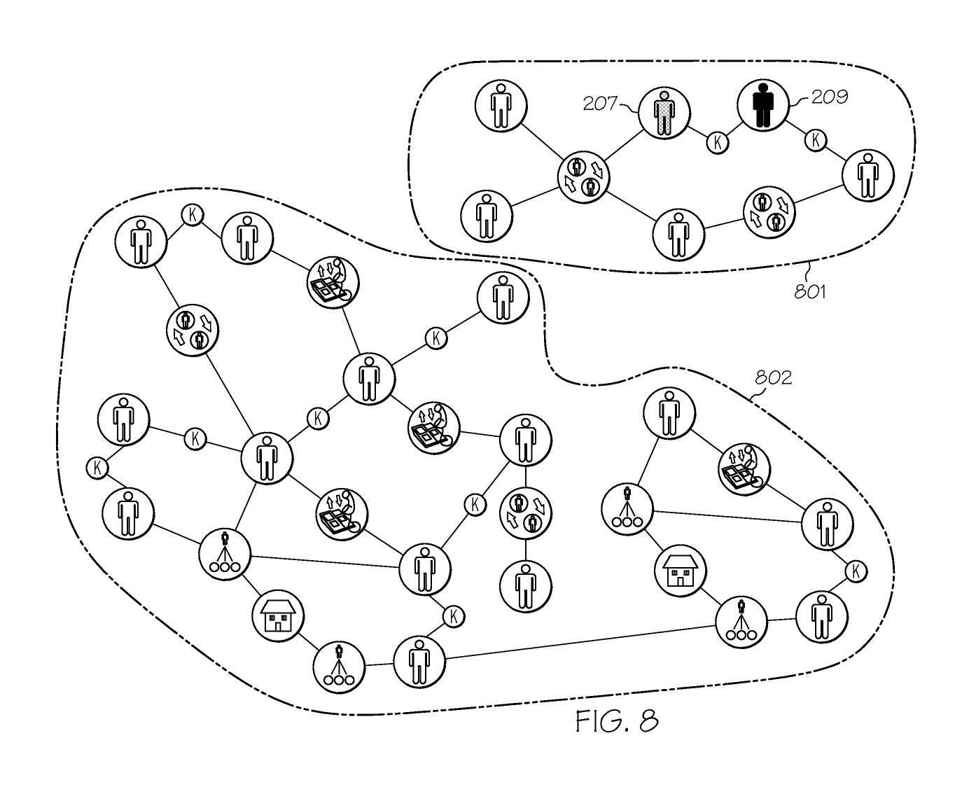

The pattern match specifications for Person A 905 in pattern graph B 910 of FIG. 9 can include “isa Person” AND pathlength (“badguy”, [2,5])” (908). As shown, in addition to local node attribute predicates, an approach can include a SNA-based predicates defined over non-local information. In this notional example, the node “is a Person” AND must be at least 2, but not more than 5 “hops” or path lengths to a known “bad guy.” The shaded regions of FIG. 7 show the inexact SNA metric calculation from the example where the user is only interested in path lengths at least 2 and no more than 5 from the matched node. Thus, from start node 701, only nodes within the specified path lengths (indicated by shaded areas 702 and 750) are of interest. This specification of path lengths limits the space of possible portions of the graph that the algorithm or process may require to search in order to determine a “bad guy,” which can reduce a computation time for the process.

With this modification, the benign visit 404 of FIG. 4 will not be matched to the pattern, while the suspect (threatening) visit 402 will be matched to the pattern and identified to the user, according to one or more embodiments. With this expansion of the graph matching provided by SNAP utility, the number of false positives returned to the user can be reduced, as a context of pre-specified interest is utilized to filter all matches prior to outputting the matches to the user.

Incorporating SNA metrics as part of the pattern matching specification can provide additional input into the suspicion scoring of the match. For example, depending on the user's objectives, an SNA metric can increase or decrease the suspicion score of the match. A user may either use the SNA metric as an additional qualifier for suspicious activity, in which case the suspicion score would increase, or the user may use the SNA metric as a qualifier for benign activity, in which case the suspicion score would decrease.

### D. Inexact SNA Metric Calculation

In one or more embodiments, an inexact SNA metric calculation can provide scalability based on the recognition that in many cases calculating a precise SNA metric value may not be necessary to make use of a metric in pattern matching. In the previously described example, the user is only interested in path lengths between 2 and 5, inclusive. As another example, the user may be interested in the degree of centrality of a particular individual. Thus, it may be enough to know that the centrality measure is “more than 0.75.” In this example, the algorithm or process only needs to perform the computations necessary to determine that an individual's centrality measure is high enough to be of interest. Once the threshold for the metric is exceeded, the computation is terminated. For instance, determining that an individual's centrality measure is high enough to be of interest can reduce computation time, since calculating many SNA metrics can be computationally expensive.

In one or more embodiments, the SNA metric calculations can be augmented to handle one or more instances where the user only cares that a certain metric falls within some interval: e.g., [lower-bound, upper-bound], where lower-bound≦metric-value≦upper-bound. In one or more cases, the SNA metrics can be monotonic, meaning that once the calculation falls within the interval, the SNAP utility stops the computation. For example, the average path length of a node in a graph is a monotonic function. If the SNAP utility is looking for a maximum path length (interval [0, max-value]), using a breadth-first search, once the current average exceeds the specified max-value, the process stops computing the metric.

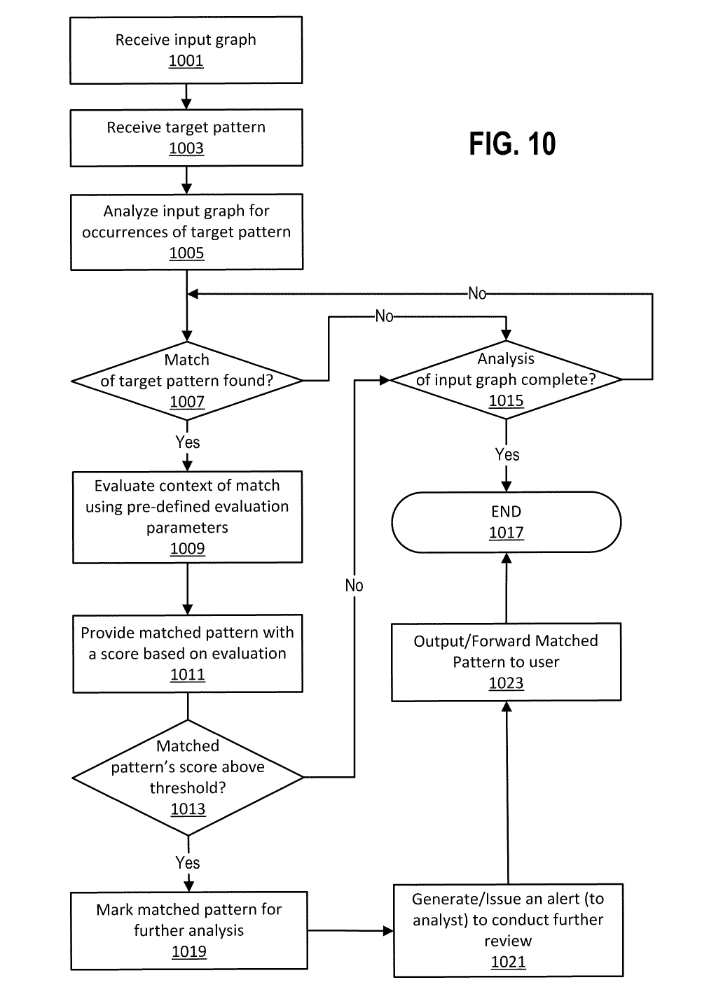

FIG. 10 is a flow chart generally illustrating a method by which the SNAP utility completes various functional features, according to one or more embodiments. At 1001, the SNAP utility receiving an input graph representation of individuals/entities that communicate with each other. The SNAP utility can also receive or access a target pattern (such as the type of pattern illustrated by FIG. 9(B)), which can define interconnectivity of interests, at 1003. Using the input graph and the target pattern, the SNAP utility evaluates the input graph for a match of the pattern graph at 1005. For instance, the SNAP utility can search for and/or analyze certain communication patterns to determine when the particular target pattern exists within the input graph. At 1007, the SNAP utility can determine whether or not a match is found within the input graph. If a match is found, the SNAP utility further evaluates the match against pre-defined conditions (or contexts) at 1009. Based on the evaluation, the matching pattern can be identified within the input graph and provided a “score” at 1011. The score assigned to the particular matching pattern can rank the pattern relative to other matching patterns based on the pre-defined conditions.

In one or more embodiments, a threshold score can be established, at which a matching patterns is identified as a pattern of interest. For example, on a scale of 1 to 10, only patterns having a score above 4 may be considered relevant for further review. Thus, all other patterns that score 4 or less can be assumed to be “false” hits and are not relevant for further consideration by the user. It is understood that the use of a scale of 1 to 10 as well as the score of 4 as the threshold are provided solely by way of example. Different scales and different thresholds may be provided/utilized in other embodiments.

At block 1013, the SNAP utility can determine whether or not the score for the particular pattern is above the threshold. For instance, determining whether or not the score for the particular pattern is above the threshold can include comparing the score against the threshold.

If the score is at or below the threshold, the method can proceed to 1015, where the process of checking the input graph for a match of the pattern of interest continues until the entire graph has been checked. An exhaustive check of the input graph can be completed and can reveal all possible matches to the pattern of interest. The manner of checking the input graph can vary from one implementation to the other. Once the graph has been completely checked, as determined at 1015, the process can end at 1017.

In one or more embodiments, the identity (location within the input graph) of the matching patterns can be stored in a database of found patterns. The match database can then be accessed by a user at a later time to perform additional evaluations or other functions with the matched patterns.

If the score is above the threshold, the SNAP utility can mark the matched pattern as relevant (or important) for further analysis at 1019. At 1021, the SNAP utility can generate an alert which identifies the matched pattern of interest. At 1023, the matched pattern can be outputted (or forwarded) to the user/analyst for further review. In one or more embodiments, outputting to the user can include displaying the matched pattern on a display (e.g., display 118 of DPS 100).

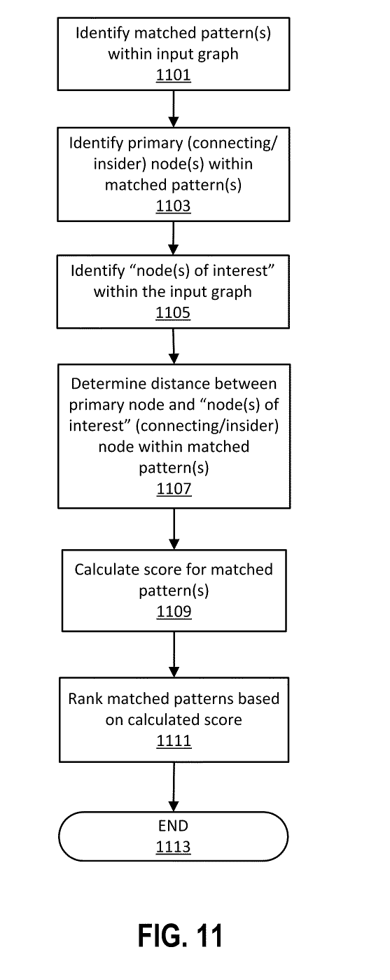

Turning now to FIG. 11 where a flow chart illustrates, in specific details, the processing by SNAP utility in calculating the score for a matched pattern when the score is weighted in inverse proportion to the degree of separation between a primary node within the matched pattern and a next node (i.e., person) of interest within the general input graph, according to one or more embodiments. Within this example, scores range from 9-to-5 based on whether the primary node is within a range of 2-to-5 hops away from the particular node of interest. That is, when the primary node is only 2 hops away, the matched pattern is given a score of 9, while when the primary node is 5 hops away, the matched pattern is given a score of 6. Additionally, an added point can be provided if the edge connecting the primary node with the node of interest is a direct (versus an indirect) communication path. Thus, a cellular phone connection between two nodes can increase the score, while a spam email shared between the nodes may not affect the score (or perhaps reduces the score).

At 1101 the matched pattern can be identified. At 1103, the SNAP utility can identify the primary node within the matched pattern. At 1105, the SNAP utility can identify the nodes (e.g., persons, entities, etc.) of interest within the input graph. With both primary node and nodes of interest identified, SNAP utility can iterate through a series of checks at 1107, to determine how far apart the two nodes actually are and other functionality associated with the edges connecting up the nodes (assuming a connecting is provided). The other functionality can include parameters that assist in providing a context for each link in the communication between the two nodes. A score is calculated during the iterative checks, at 1109, and the scores of the various matched patterns can be ranked relative to the pre-set scale, at 1111. The process can end at 1113.

### E. Recommending or Predicting One or More Patterns for a User

In one or more embodiments, collaborative utility 150 can apply social network analysis to graph matching to increase the relevance ranking of one or more graph pattern results (e.g., one or more of matched patterns 402, 404, 801, 802, etc.) based on pattern ratings from multiple users. The one or more results of graph pattern matching, which can include a ranked list of patterns, can be too much for a human analyst to consume, analyze, and/or utilize. In such instances, the problem can be to determine which patterns are more/most relevant. In one or more embodiments, collaborative utility 150 can rank the thousands of patterns and improve the relevance of the ranked patterns. For example, computer network events and/or patterns are like a signature of an attacker who is typically automating a series of steps to find, penetrate, and/or lie in wait, and a human analyst cannot find these patterns amongst billions of network events. The specific type of social network analysis technology applied is collaborative filtering, e.g., a method to filter information or patterns based on collaborative input from multiple users that can rank results linked to a wide variety of data sets recommended by the multiple users which can determine which ones are more/most relevant, according to one or more embodiments.

In one or more embodiments, collaborative utility 150 can accelerate speed and accuracy of assessment performed by the analyst on enriched data sets. For instance, collaborative utility 150 can include and/or implement a method of memory-based collaborative filtering that can generate pattern and data recommendations from multiple data sources, thereby enhancing a single user's analysis originally based solely on a single data source. In one or more embodiments, collaborative utility 150 can be applied to computer network defense and/or emerging social media. For example, collaborative filtering can increase computer network defense situational assessment by applying collaborative filtering methods described herein to combine computer network results, retrieved by graph pattern matching, with emerging media.

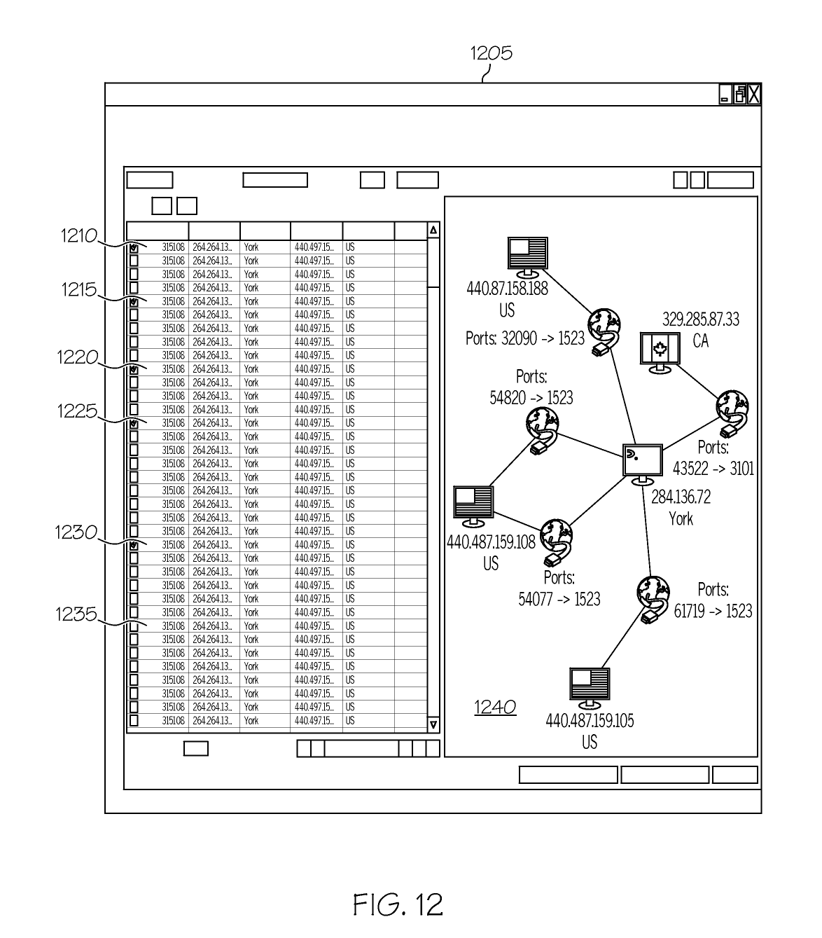

For example, each of one or more retrieved computer network threat patterns 1210-1235 illustrated in FIG. 12 can include many (e.g., thousands, hundreds of thousands, millions, billions, etc.) computer network events. As shown, one or more patterns 1210-1235 and graphical representation 1240 (e.g., a graphical representation of a matched graph pattern, such as pattern 1220) can be displayed in a graphical user interface 1205. In one or more embodiments, a user can rate a pattern. For example, the user can rate pattern 1220 represented via graphical representation 1240. In one or more embodiments, users of a community of users (e.g., a division of the FBI, a division in a military, a division of a security consulting agency, network analysts, etc.) can rate one or more patterns 1210-1235, and one or more collaborative filtering methods and/or processes described can be used to recommend one or more additional patterns which can be explored and/or analyzed.

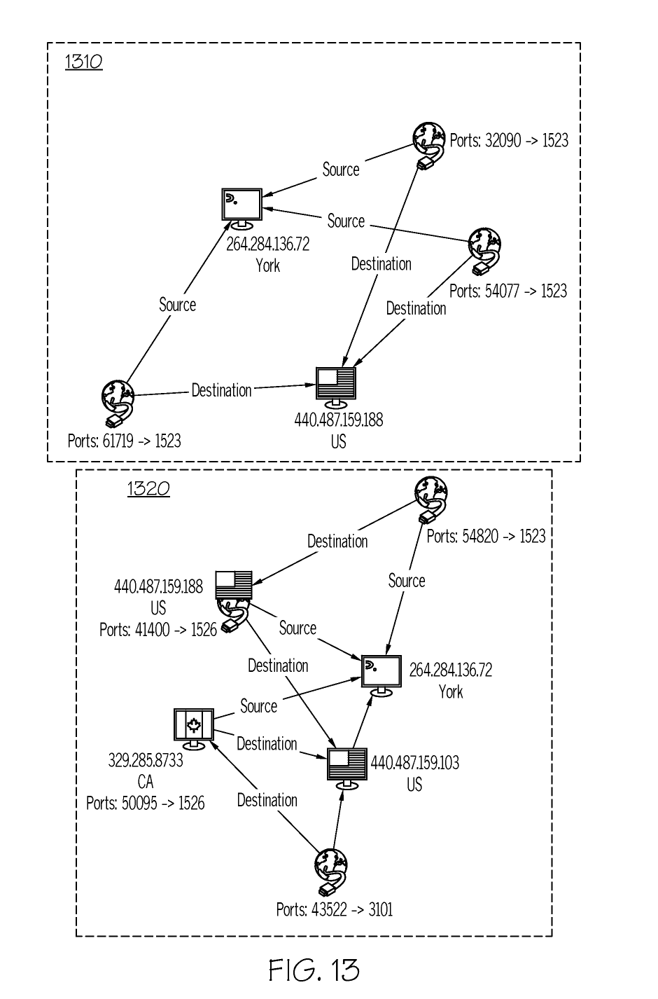

In one or more embodiments, one or more recommendations can be based on similar feature sets of a pattern rated by a user and others in the community of the user and/or their social network. For example, users and/or others can rate patterns of various feature sets in training tests at an onset of their analyses. In one instance, collaborative utility 150 might recommend additional computer network events of interest that are linked to enriched data sets such as images or video found from the Internet. In another instance, collaborative utility 150 might recommend one or more patterns 1310 and 1320 illustrated in FIG. 13.

In one or more embodiments, collaborative utility 150 can receive user input indicating one or more parameters that a user considers significant (e.g., a high rating). In one example, the user input can indicate an Internet protocol (IP) address. In another example, the user input can indicate a geographic location (e.g., an air force base (AFB)). After receiving the user input indicating one or more parameters that a user considers significant, collaborative utility 150 can perform one or more collaborative filtering methods and/or processes that can provide further recommended patterns.

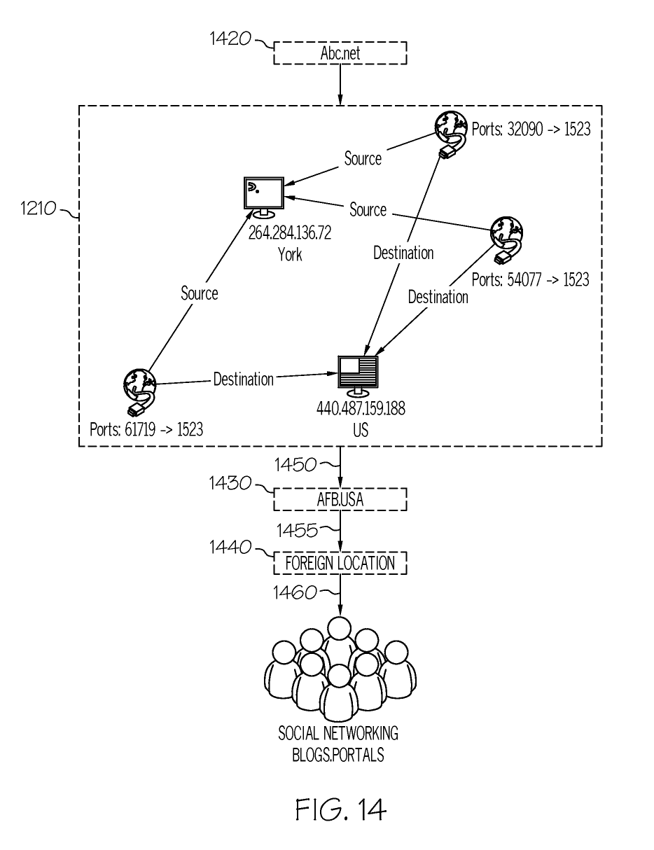

For example, a illustrated in FIG. 14, collaborative utility 150 can receive an IP address or a fully qualified domain name (FQDN) 1420 (e.g, “abc.net”) and a geographic location 1430 (e.g., “AFB, USA”) as notionally selected by a user and can link data flows 1450-1460 to pattern 1210 through imagery and cyberdata based on one or more ratings or recommendations from a community of users. For instance, collaborative utility 150 can provide, using the one or more ratings from a community of users, an acceleration of a line of analysis about a particular cyber threat pattern (e.g., pattern 1210). In one or more embodiments, a user can identify social network intelligence based on one or more cyber threat patterns.

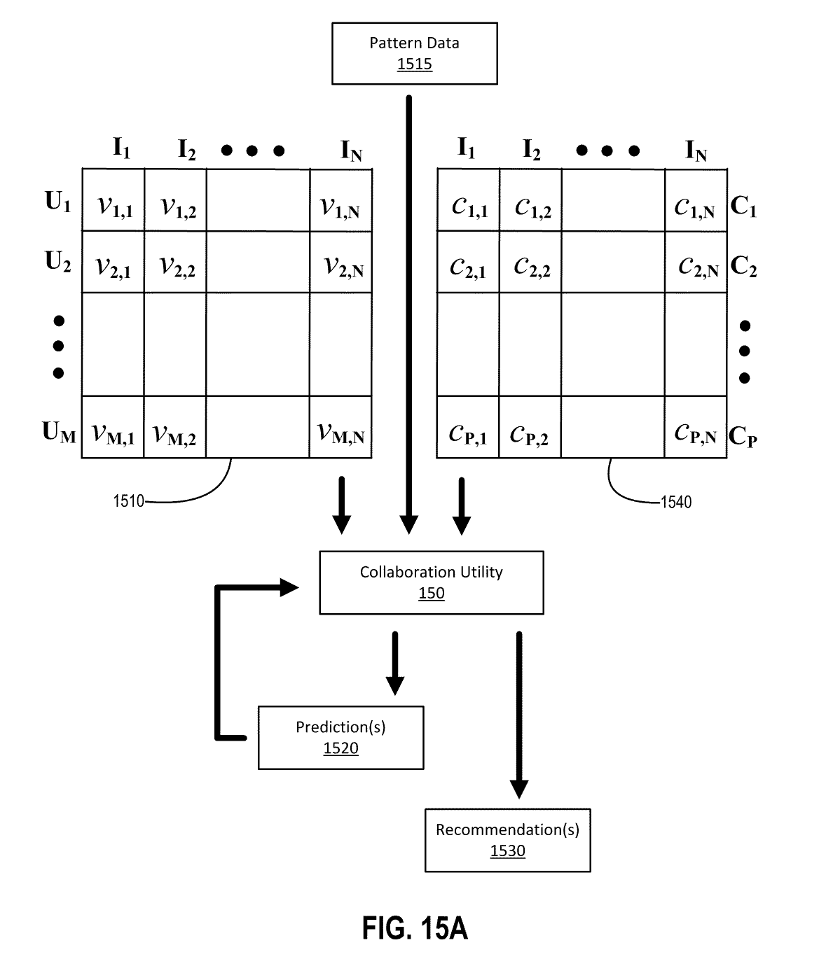

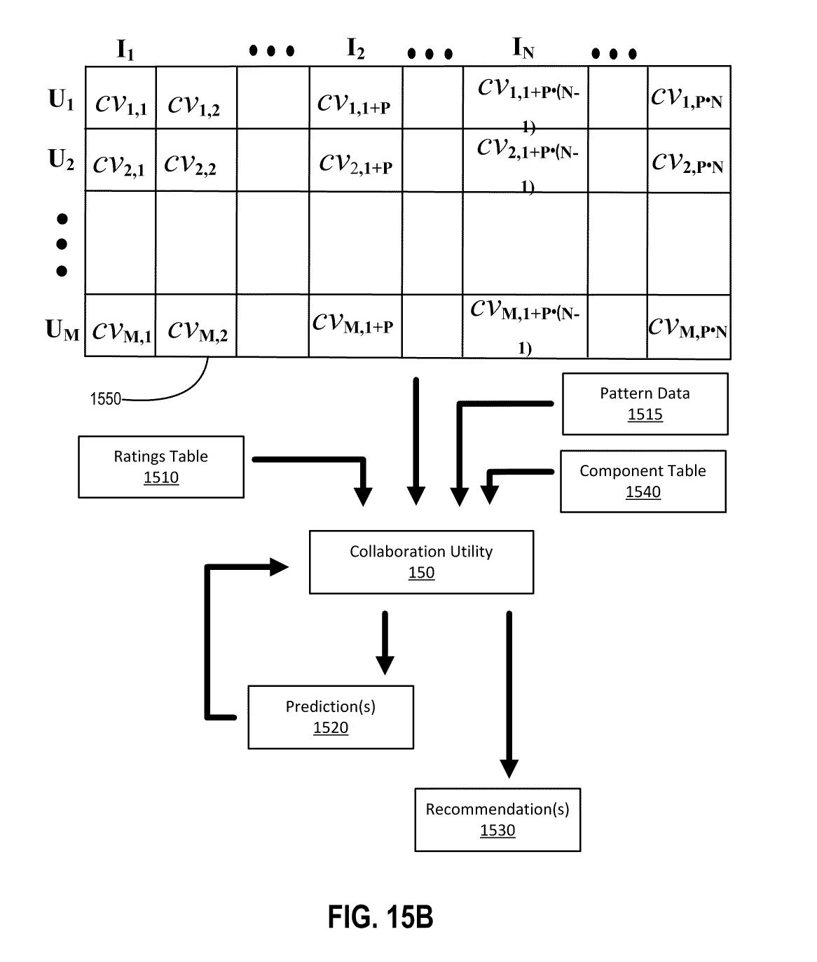

Turning now to FIG. 15A, a high-level flow diagram of a ratings table, pattern data, a pattern component table, a collaborative utility, predictions, and recommendations is illustrated, according to one or more embodiments. As shown, a ratings table or matrix 1510 can include multiple votes or ratings from users U₁-U_{M} (for some integer M greater than one) on patterns or items I₁-I_{N} (for some integer N greater than one). In one example, ratings or votes V_{2,1}-V_{2,N} can correspond to ratings or votes of user U₂ for items I₁-I_{N}. In another example, ratings or votes V_{1,1}-V_{M,1} can correspond to ratings or votes of users U₁-U_{M} for item I₁. In one or more embodiments, each of ratings or votes can include a number. For example, the number can be from one to five. For instance, if a user (e.g., U₃) has not rated an item or pattern (e.g., I₄), then a rating value (e.g., V_{3,4}) can include a zero value that can indicate that the user has not voted on the item. Other examples can include ratings or votes indicating a number within another range.

In one or more embodiments, matrix 1510 can be stored in a data structure. In one example, matrix 1510 can be stored as a two-dimensional array in a memory. For instance, matrix 1510 can include a vote or rating vector (V_{a,1}, . . . , V_{a,N}) for an active user Uₐ and can include a vote or rating vector (V_{i,1}, . . . , V_{i,N}) for another user Uᵢ. In one or more embodiments, a vector can be or include an array of elements. For example, vote or rating vector (V_{a,1}, . . . , V_{a,N}) can be or include an array of elements V_{a,1}, . . . , V_{a,N}.

In one or more embodiments, matrix 1510 can be indexed via a user and an item pair. For example, V_{i,j} can include a vote or rating of user i on item j, and i and j can be used to index into matrix 1510 to retrieve and/or obtain vote or rating V_{i,j}. In one instance, i and j can be used as indices into matrix 1510. In another instance, i and j can be used to calculate a memory offset to V_{i,j}, and the memory offset can be an index into matrix 1510.

In another example, matrix 1510 can be stored in a database. For instance, matrix 1510 can be stored in a table of the database. In one or more embodiments, matrix 1510 can be indexed via a row and a column pair. For example, rows of the table can correspond to the users, and columns of the table can correspond to items. For instance, an index to a rating can be selected via <Uᵢ, Iⱼ> where Uᵢ is the selected user and Iⱼ is the pattern rated by Uᵢ.

In one or more embodiments, a pattern can include multiple components. In one example, the components can include one or more nodes of a pattern (e.g., one or more of P7, P8, P9, A3, A4, and L2 of pattern 404). In another example, the components can include one or more edges of a pattern (e.g., edge K between P8 and P9 of pattern 404, one or more of edge K between P9 and P12 and edge K between P10 and P12, etc.). As illustrated, a component table or matrix 1540 can include data indicating one or more utilizations of components C₁-C_{P} (for some integer P greater than one) of patterns or items I₁-I_{N}.

In one or more embodiments, computer network events can be represented as patterns, where each computer network event can include computer network event data. For instance, the computer network event data can include one or more components C₁-C_{P} such as one or more of a source IP address, a destination IP address, a source media access control (MAC) address, a destination MAC address, a source port number, a destination port number, a protocol, an ingress interface identification, a type of service identification, a packet length, a sequence number (e.g., a transport control protocol (TCP) sequence number), a source geographic location (e.g., topographic area, city, state, country, etc.), and a destination geographic location (e.g., topographic area, city, state, country, etc.), among others. For example, computer network event data can include data associated with one or more NetFlow services described in Request for Comments (RFC) 3954 available from the Internet Engineering Task Force (IETF). In one or more embodiments, network elements (e.g., switches, routers, etc.) can gather computer network event data and can export the computer network event data to a collector (e.g., a database, a computer system, etc.). For example, one or more systems at a location (e.g., location 1430) can include one or more network elements that can gather computer network event data and can export the computer network event data to a collector.

In one or more embodiments, matrix 1540 can be stored in a data structure. In one example, matrix 1540 can be stored as a two-dimensional array in a memory. In another example, matrix 1540 can be stored in a database. For instance, matrix 1540 can be stored in a table of the database. In one or more embodiments, matrix 1540 can be indexed via a component and an item pair. For example, C_{i,j} can indicate whether or not a component i is included in a pattern j, and i and j can be used to index into matrix 1540 to retrieve and/or obtain C_{i,j}.

In one or more embodiments, matrix 1540 can be stored in a data structure. In one example, matrix 1540 can be stored as a two-dimensional array in a memory. In one or more embodiments, matrix 1540 can be indexed via a component and an item pair. For example, C_{i,j} can indicate whether or not a component i is included in a pattern j, and i and j can be used to index into matrix 1540 to retrieve and/or obtain C_{i,j}. In one instance, i and j can be used an indices into matrix 1540. In another instance, i and j can be used to calculate a memory offset to C_{i,j}, and the memory offset can be an index into matrix 1540.

In another example, matrix 1540 can be stored in a database. For instance, matrix 1540 can be stored in a table of the database. In one or more embodiments, matrix 1540 can be indexed via a row and a column pair. For example, rows of the table can correspond to the components, and columns of the table can correspond to items. For instance, an index to a rating can be selected via <Cᵢ, Iⱼ> where Cᵢ is the selected component and Iⱼ is the selected pattern.

As illustrated, collaborative utility 150 can receive one or more of data from matrix 1510, pattern data 1515, and data from component matrix 1540. In one or more embodiments, collaborative utility 150 can calculate one or more predictions 1520 and/or one or more recommendations 1530 based on one or more of data from matrix 1510, pattern data 1515, and data from component matrix 1540.

In one or more embodiments, collaborative utility 150 can determine that components of a first pattern match components of a second pattern. For example, the first pattern can be represented by pattern data 1515, and collaborative utility 150 can determine that components of pattern data 1515 match corresponding components of the second pattern. For instance, collaborative utility 150 can determine that components C₂ (e.g., a destination IP address), C₆ (e.g., a destination port), and C₁₀ (e.g., a packet length) of pattern data 1515 match respective components C₂, C₆, and C₁₀ of pattern I₂. For example, an active user, Uₐ (for a in 1 to M), of collaborative utility 150 may not have rated or reviewed pattern I₂.

In one or more embodiments, collaborative utility 150 can determine that components of the first pattern match components of multiple patterns and can recommend a top number of other patterns to the active user based on ratings of the active user for other patterns and pattern ratings of other users (e.g., users in a community of users). For instance, collaborative utility 150 can determine that components of the first pattern match components of each of patterns {I₁, I₈, I₁₀, I₂₀, I₂₃, I₂₇, I₃₁, I₄₅, I₅₀}. In one example, the top number of other patterns can include multiple patterns that the active user has not reviewed or rated and match components of the first pattern. For instance, the active user may not have reviewed or rated patterns {I₁, I₈, I₁₀, I₂₀, I₂₃, I₂₇, I₃₁, I₄₅, I₅₀}, and collaborative utility 150 can rank and recommend one or more of patterns {I₁, I₈, I₁₀, I₂₀, I₂₃, I₂₇, I₃₁, I₄₅, I₅₀}.

In one or more embodiments, collaborative utility 150 can perform one or more collaborative filtering methods and/or processes that utilize ratings or votes of matrix 1510 to produce a top number of recommendations of an active user Uₐ (for a in 1 to M) based on numerically ranking the calculations of p_{a,j}, a prediction score for pattern or item j of active user Uₐ. For example, collaborative utility 150 can calculate {p_{a,1}, p_{a,8}, p_{a,10}, p_{a,20}, p_{a,23}, p_{a,27}, p_{a,31}, p_{a,45}, p_{a,50}} (e.g., predictions 1520), can sort the predictive ratings {p_{a,1}, p_{a,8}, p_{a,10}, p_{a,20}, p_{a,23}, p_{a,27}, p_{a,31}, p_{a,45}, p_{a,50}} (e.g., sorting from highest to lowest), and can rank patterns {Iᵢ, I₈, I₁₀, I₂₀, I₂₃, I₂₇, I₃₁, I₄₅, I₅₀} based on the sorted predictive ratings. For instance, the sorted predictive ratings can include {p_{a,8}, p_{a,45}, p_{a,20}, p_{a,23}, p_{a,50}, p_{a,27}, p_{a,1}, p_{a,31}, p_{a,10}} which can be used to rank the patterns as {I₈, I₄₅, I₂₀, I₂₃, I₅₀, I₂₇, I₁, I₃₁, I₁₀}. For example, the top number of recommendations (e.g., recommendations 1530) can include {I₈, I₄₅, I₂₀, I₂₃, I₅₀} (e.g., a top-five ranked patterns).

In one or more embodiments, computer network events can be flagged by an intrusion detection system (IDS) (e.g., a Common Intrusion Detection Director System (CIDDS)) and can be included in matrix 1510. In one example, an exfiltration pattern, which belongs to a class of computer network exploitation patterns and is a computer network event, can include two steps. For instance, an IDS captures a reconnaissance or penetration attempt from attacker to target, then the information is sent from target to attacker. For example, the IDS can capture information from a host which can be then sent to the attacker for exploitation. For instance, the information captured by the IDS can include computer network event data associated with communications between the host and the attacker that uses the information to exploit the host.

Turning now to FIG. 15B, a high-level flow diagram of a ratings table, pattern data, a pattern component table, a component ratings table, a collaborative utility, predictions, and recommendations is illustrated, according to one or more embodiments. As shown, a component ratings table or matrix 1550 can include multiple votes or ratings from users Uₗ-U_{M} on components of patterns or items Iₗ-I_{N}. In one or more embodiments, utilizing component matrix 1550 can provide further detail associated with one or more components of a pattern. For example, each of component ratings or votes can include a number (e.g., the number can be from one to five, other examples can include ratings or votes indicating a number within another range, etc.). In one or more embodiments, collaborative utility 150 can perform one or more collaborative filtering methods and/or processes that utilize component ratings or votes of component matrix 1550 to produce a top number of recommendations of an active user Uₐ based on numerically ranking the calculations of p_{a,j}, a prediction score for pattern or item j of active user Uₐ.

In one example, a first user U₁ can rate CV_{1,1} with a value of four and can rate CV_{1,3} with a value of two, and a second user U₂ can rate CV_{2,1} with a value of one and can rate CV_{2,3} with a value of five. For instance, CV_{1,1} and CV_{2,1} can correspond to component C₁ of pattern I₁. For example, component C₁ of pattern I₁ can be associated with a MAC address and component C₃ of pattern I₁ can be associated with an IP address. For instance, CV_{1,1} and CV_{2,1} can indicate that a MAC address of pattern Iᵢ has greater importance to Uᵢ than U₃, and CV_{1,3} and CV_{2,3} can indicate that an IP address of pattern Iᵢ has greater importance to U₃ than Uᵢ.

In another example, one or more users may not have reviewed or rated each component of a pattern. In one instance, if a user (e.g., U₃) has not rated component (e.g., CV_{3,2}) of an item or pattern (e.g., Iᵢ), then a rating value for the component can be the rating of the item of pattern. For example, user U₃ may have rated Iᵢ as two and did not rate CV_{3,2}, so CV_{3,2} can receive a rating of two as well. In another instance, if a user (e.g., U₃) has not rated component (e.g., CV_{3,2}) of an item or pattern (e.g., Iᵢ), then a rating value for the component can include a zero value that can indicate that the user has not voted a rating for the component.

As illustrated, each pattern or item can include a number (for some number P greater than one) components. In one example, component ratings or votes CV_{2,1}-CV_{2,P} can correspond to ratings or votes of user U₂ for components of pattern or item Iᵢ. In another example, component ratings or votes CV_{2,1+P}-CV_{2,2P} can correspond to ratings or votes of user U₂ for components of pattern or item I₂.

In one or more embodiments, matrix 1550 can be stored in a data structure. In one example, matrix 1550 can be stored as a two-dimensional array in a memory. For instance, matrix 1550 can include a vote or component rating vector (CV_{a,1}, . . . , CV_{a,P·N}) for an active user Uₐ and can include a component vote or rating vector (CV_{i,1}, . . . , CV_{i,P·N}) for another user Uᵢ. In one or more embodiments, a vector can be or include an array of elements. For example, component vote or rating vector (CV_{a,1}, . . . , CV_{a,P·N}) can be or include an array of elements CV_{a,1}, . . . , CV_{a,P·N}. In one or more embodiments, matrix 1550 can be indexed via a user i, item j, and component k of item j. For example, i, j, and k can be used as indices into matrix 1550. In another instance, i, j, and k can be used to calculate a memory offset to a component rating, and the memory offset can be an index into matrix 1550.

In another example, matrix 1550 can be stored in a database. For instance, matrix 1550 can be stored in a table of the database. In one or more embodiments, matrix 1550 can be indexed via a row and a column pair. For example, rows of the table can correspond to the users, and columns of the table can correspond to components of items. For instance, an index to a component rating can be selected via <Uᵢ, I_{j,k}> where Uᵢ is the selected user and I_{j,k} is the pattern pattern rated by Uᵢ. In one or more embodiments, matrix 1550 can be stored in multiple tables of the database. For example, each of the tables can correspond to a pattern, and each table corresponding to a pattern can include rows corresponding to the users and columns corresponding components of the pattern.

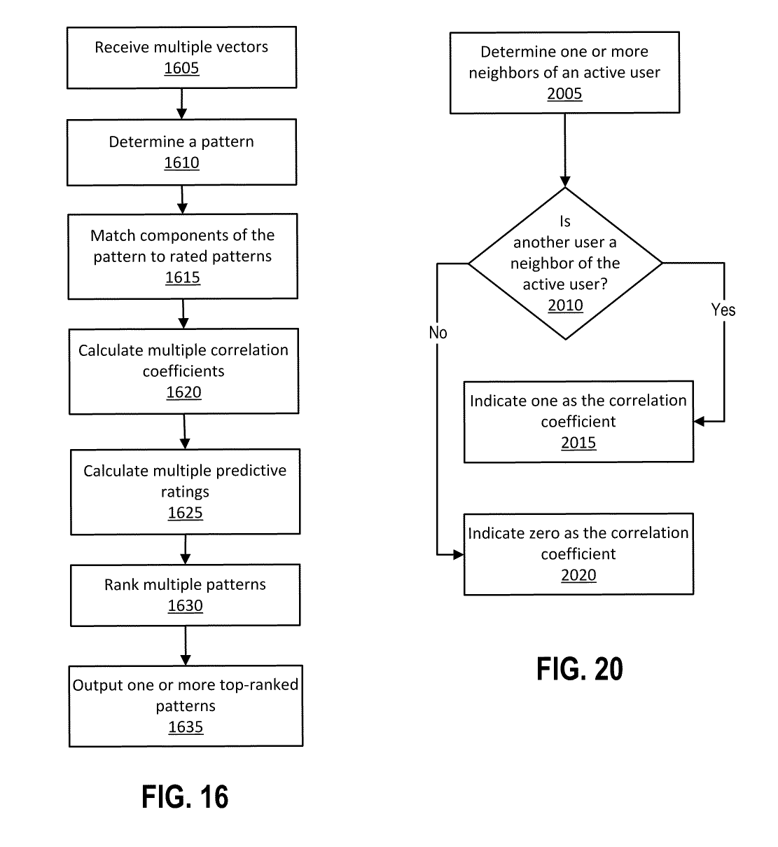

Turning now to FIG. 16, a method that recommends one or more patterns is illustrated, according to one or more embodiments. At 1605, collaborative utility 150 can receive multiple vectors corresponding to multiple users. For example, collaborative utility 150 can receive vectors of matrix 1510 and/or matrix 1550. In another example, collaborative utility 150 can receive vectors of component matrix 1550. In one or more embodiments, receiving the vectors of matrix 1510 and/or matrix 1550 can include accessing a data structure that stores matrix 1510 and/or matrix 1550 and receiving the vectors from a memory and/or database that stores the data structure. At 1607, collaborative utility 150 can receive network event data.

At 1610, collaborative utility 150 can determine a pattern from the network event data. In one or more embodiments, the determined pattern can be represented as pattern data (e.g., pattern data 1515). At 1615, collaborative utility 150 can match components of the pattern with rated patterns. For example, collaborative utility 150 determine that components of pattern data 1515 match corresponding components rated patterns from matrix 1510.

At 1620, collaborative utility 150 can calculate, based on a vector corresponding to an active user (e.g., Uₐ) and the multiple vectors, multiple correlation coefficients. In one or more embodiments, the correlation coefficients can be used as weights to rank patterns. At 1625, collaborative utility 150 can calculate, based on the multiple of correlation coefficients, multiple predictive ratings for the multiple patterns. At 1630, collaborative utility 150 can rank the multiple patterns based on the multiple predictive ratings. In one or more embodiments, ranking the patterns based on the predictive ratings can include sorting the predictive ratings from a high predictive rating of the predictive ratings to a low predictive rating of the predictive ratings and ordering the patterns based on the predictive ratings sorted from the high predictive rating to the low predictive rating. For example, ranking the patterns based on the predictive ratings can create an ordered set of the patterns, e.g., {a first pattern corresponding to the high predictive rating, . . . , a last pattern corresponding to the low predictive rating}.

At 1635, collaborative utility 150 can output one or more patterns. For example, collaborative utility 150 can output top-ranked patterns. For instance, collaborative utility 150 can output a first number (e.g., 1, 2, 3, 4, etc.) of elements or members of the ordered set of the multiple patterns. In one or more embodiments, outputting the top-ranked patterns can include storing the top-ranked patterns in a storage medium or a database and/or outputting the top-ranked patterns to a display (e.g., display 118). For example, collaborative utility 150 can output the first number of elements or members of the ordered set of the multiple patterns to the display. For instance, collaborative utility 150 can output the first three elements or members of the ordered set of the patterns to the display.

In one or more embodiments, a predictive rating can be a prediction score of the pattern that can be used in numerically ranking one or more calculations of p_{a,j}, a prediction score for item j of active user Uₐ. For example, the method illustrated in FIG. 16 can be used to correlate or cluster the user or item vectors of a ratings table (e.g., matrix 1510 or matrix 1550). User or item vectors that are similar can be considered to be correlated or belong to a same cluster. Recommendations of items (e.g., patterns) can be based on elements included within similar clusters or sets of correlated user vectors. In one or more embodiments, recommendations of the items (e.g., patterns) can include the first number of elements or members of the ordered set of the patterns. Collaborative utility 150 can include and/or implement a collaborative filtering process and/or method that uses the multiple correlation coefficients to calculate a similarity between two user or item vectors and/or can produce a prediction for the active user (e.g., Uₐ) by taking a weighted average of all ratings for the items.

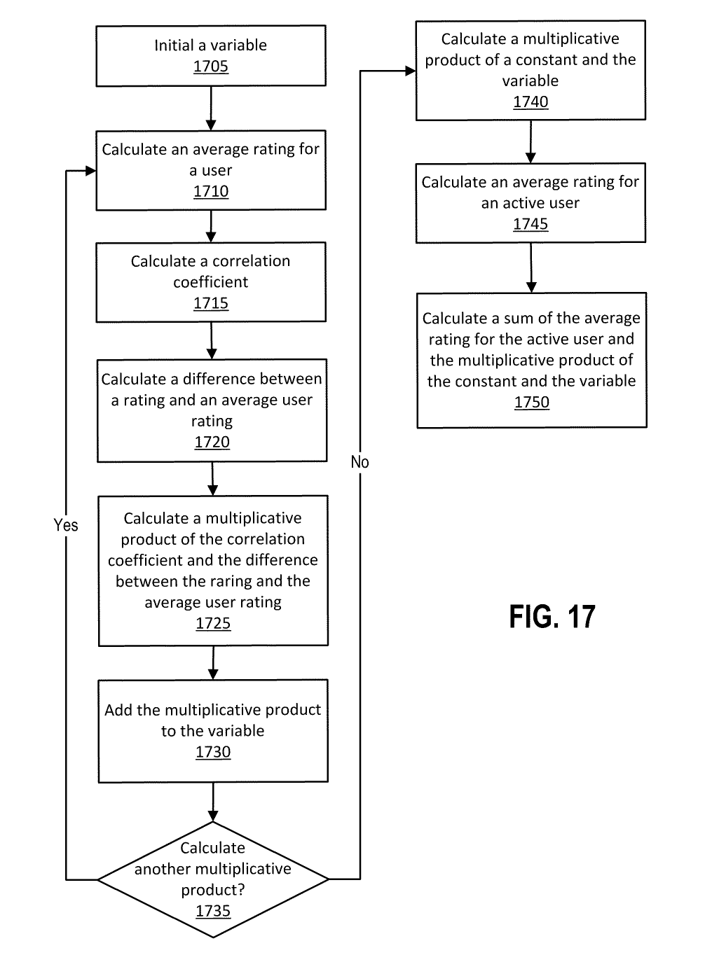

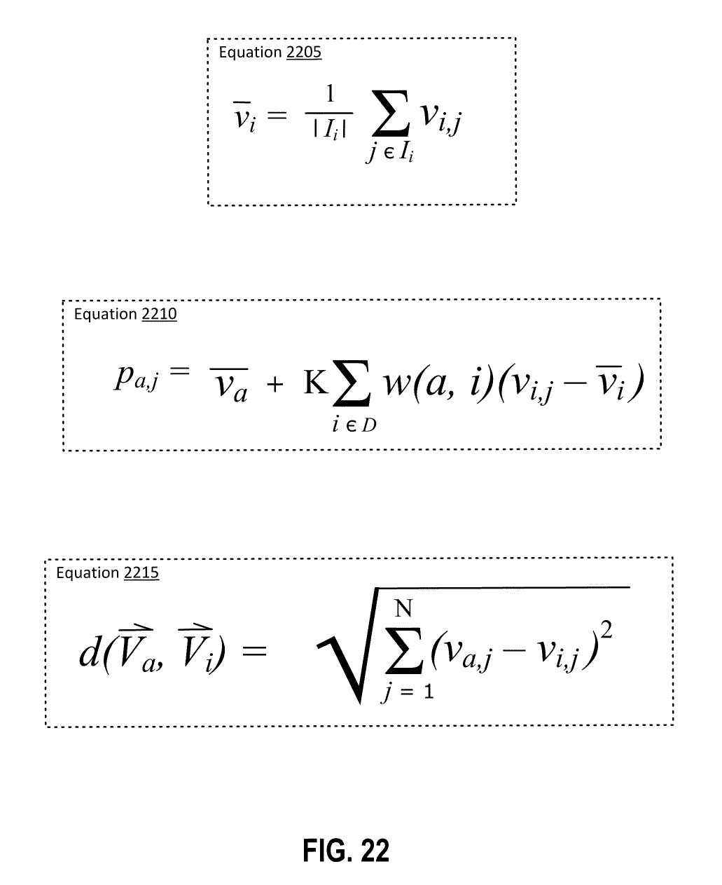

Turning now to FIG. 17, a method of calculating a predictive rating for an active user and an item is illustrated, according to one or more embodiments. At 1705, collaborative utility 150 can initialize a variable to zero. In one or more embodiments, the variable can be used to store a sum of numbers. At 1710, collaborative utility 150 calculates an average rating for a user. For example, the average rating for the user can be an average rating across all items for which the user has provided a rating. For instance, an average rating for a user Uᵢ can be calculated by computing equation 2205 of FIG. 22, where Iᵢ is a set of numbers that corresponds to indexes of patterns that user Uᵢ has rated.

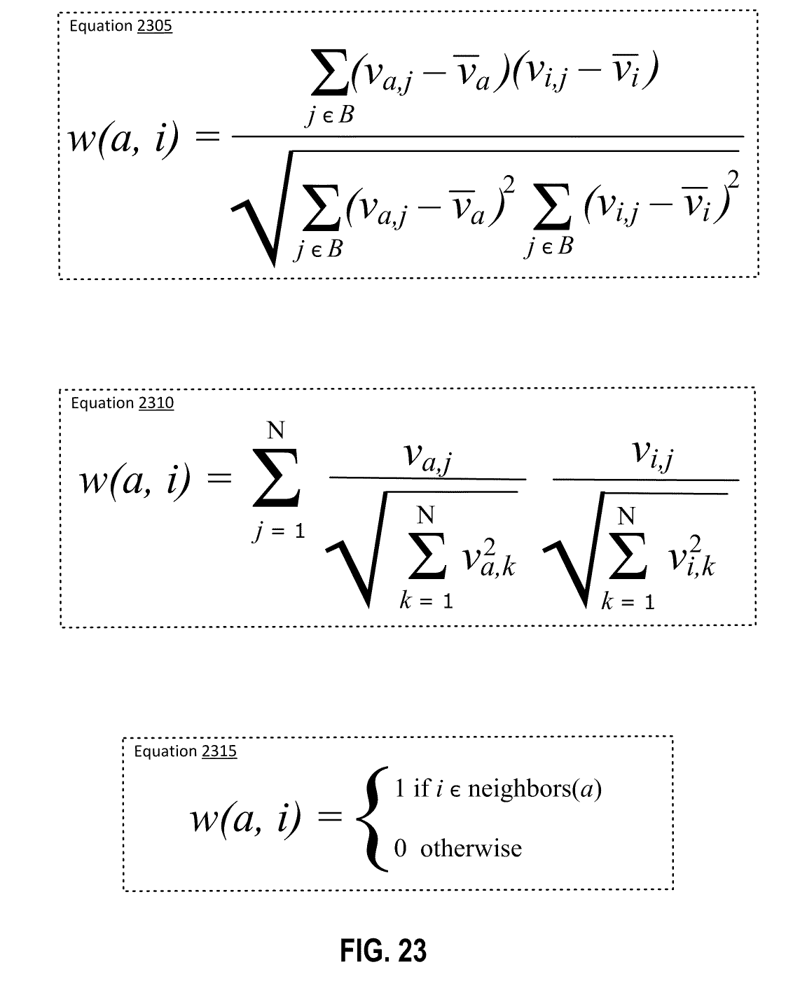

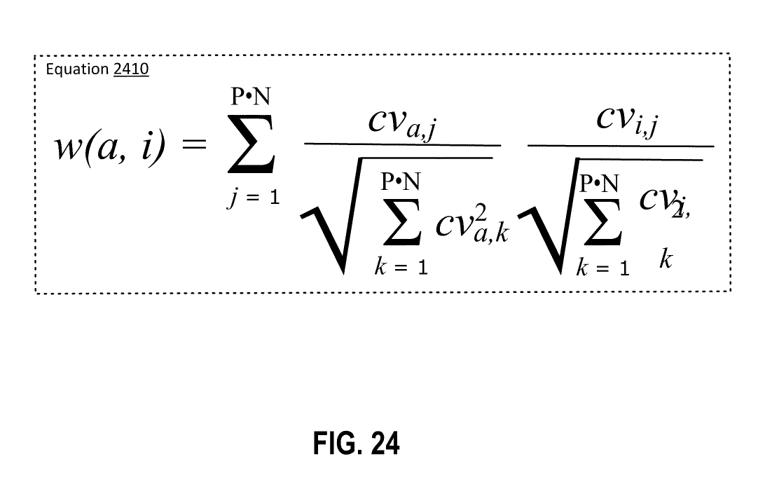

At 1715, collaborative utility 150 can calculate a correlation coefficient. In one or more embodiments, the correlation coefficient can be utilized as a metric or measure of a correlation or similarity between an active user Uₐ and another user Uᵢ(e.g., another user of a community of users). For example, collaborative utility 150 can calculate the correlation coefficient utilizing one or more methods and/or processes to calculate w(a, i) from one of equations 2305-2315 of FIG. 23 and equation 2410 of FIG. 24. At 1720, collaborative utility 150 can calculate a difference between a vote or rating and the average rating for the user U, (i.e., V_{i,j}− V̅ᵢ for an item index j).

At 1725, collaborative utility 150 can calculate a multiplicative product of the correlation coefficient and the difference between the vote or rating and the average rating for the user Uᵢ. For example, calculating the multiplicative product of the correlation coefficient and the difference between the vote or rating and the average rating for the user Uᵢ can include multiplying the correlation coefficient and the difference between the vote or rating and the average rating for the user Uᵢ. For instance, w(a,i)(V_{i,j}− V̅ᵢ) can be calculated at 1725.

At 1730, collaborative utility 150 can add the multiplicative product to the variable. At 1735, collaborative utility 150 can determine whether or not another multiplicative product is to be calculated for another user. For example, collaborative utility 150 can calculate multiplicative products for each element of a set D of user indexes corresponding to users that have provided a rating for item j.

If another multiplicative product is to be calculated for another user, the method can proceed to 1710. If another multiplicative product is not to be calculated for another user, collaborative utility 150 can calculate a multiplicative product of a constant (e.g., a constant K) and the variable, at 1740. For example, calculating the multiplicative product of the constant and the variable can include multiplying the constant and the variable. In one or more embodiments, the constant K can be utilized as a normalizing factor such that a sum of the absolute values of w(a,i) is one (or another unity value). At 1745, collaborative utility 150 can calculate an average rating for the active user Uₐ.

At 1750, collaborative utility 150 can calculate a sum of the average rating for the active user Uₐ and the multiplicative product of the constant and the variable. In one or more embodiments, the predictive rating for the active user Uₐ and the item is the sum of the average rating for the active user Uₐ and the multiplicative product of the constant and the variable. In one or more embodiments, the method illustrated in FIG. 17 can calculate a predictive rating for active user Uₐ and an item j (i.e., p_{a,j}). For example, the method illustrated in FIG. 17 can calculate p_{a,j} of equation 2210 of FIG. 22.

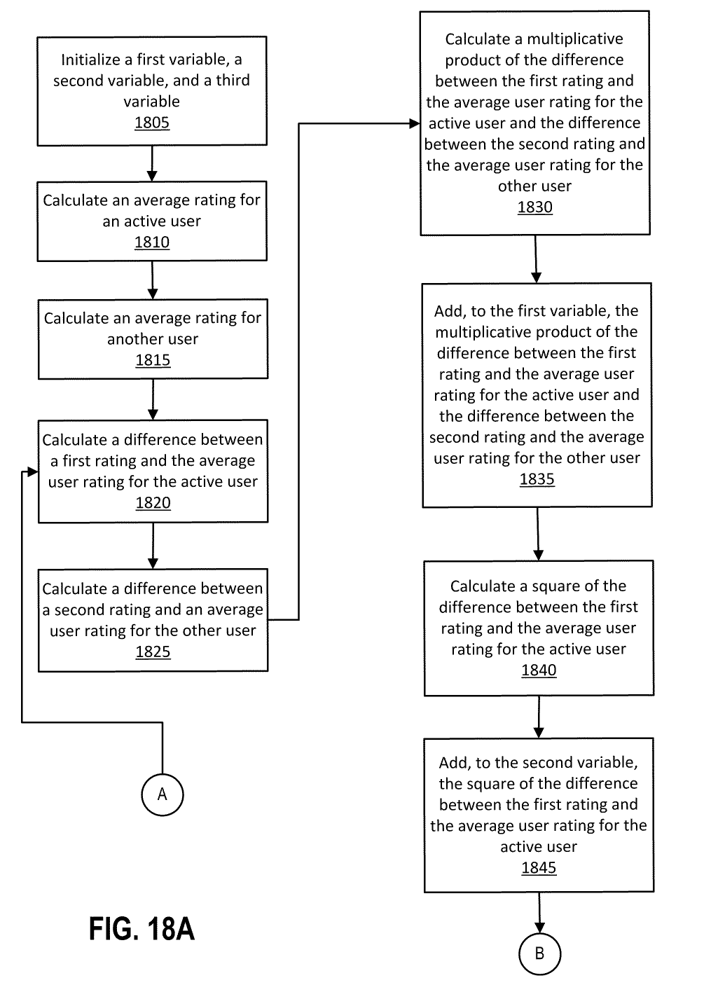

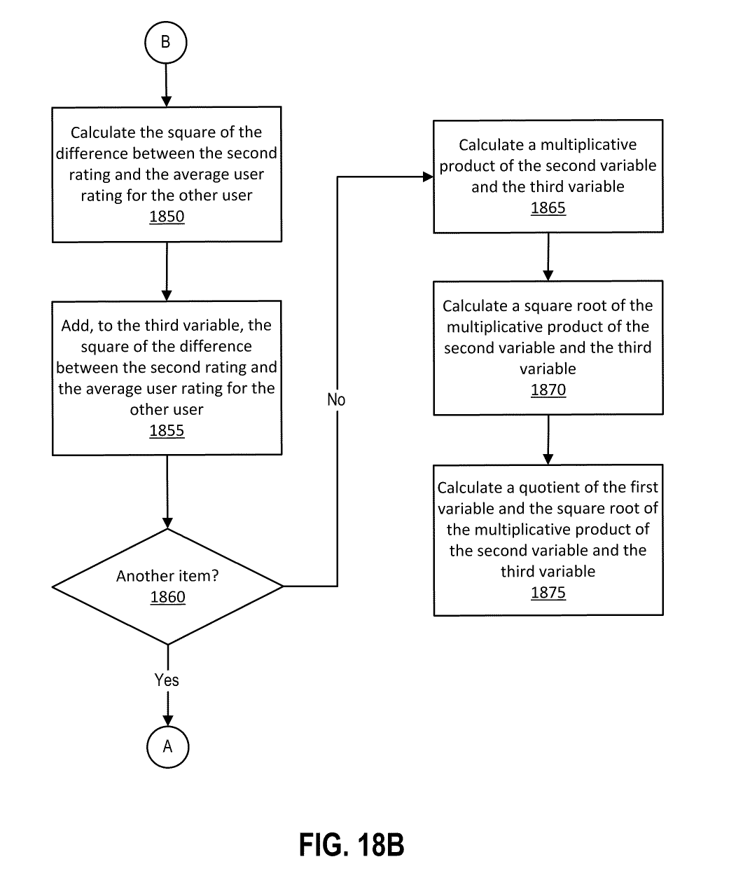

Turning now to FIGS. 18A and 18B, a method of calculating a correlation coefficient is illustrated, according to one or more embodiments. At 1805, collaborative utility 150 can initialize a first variable, a second variable, and a third variable to zero. In one or more embodiments, each of the first variable, the second variable, and the third variable can be used to store a sum of numbers. At 1810, collaborative utility 150 can calculate an average rating V̅ₐ for an active user Uₐ. At 1815, collaborative utility 150 can calculate an average rating V̅ᵢ for another user Uᵢ. At 1820, collaborative utility 150 can calculate a difference between a first rating V_{a,j} and the average rating for an active user Uₐ (i.e., V_{a,j}− V̅ₐ for an item index j). At 1825, collaborative utility 150 can calculate a difference between a second rating V_{i,j} and the average rating for the other user Uᵢ (i.e., V_{i,j}− V̅ᵢ for an item index j).

At 1830, collaborative utility 150 can calculate a multiplicative product of the difference between the first rating V_{a,j} and the average rating V̅ₐ for the active user Uₐ and the difference between the second rating V_{i,j} and the average rating V̅ᵢ for the other user Uᵢ. For example, collaborative utility 150 can, at 1830, calculate (V_{a,j}− V̅ₐ)(V_{i,j}− V̅ᵢ). At 1835, collaborative utility 150 can add the multiplicative product, calculated at 1830, to the first variable.

At 1840, collaborative utility 150 can calculate a square of the difference between the first rating V_{a,j} and the average rating V̅ₐ for the active user Uₐ. For example, collaborative utility 150 can, at 1840, calculate (V_{a,j}− V̅ₐ)². At 1845, collaborative utility 150 can add the square of the difference between the first rating V_{a,j} and the average rating V̅ₐ for the active user Uₐ, calculated at 1840, to the second variable.

At 1850, collaborative utility 150 can calculate a square of the difference between the second rating V_{i,j} and the average rating for the other user Uᵢ. For example, collaborative utility 150 can, at 1850, calculate (V_{i,j}− V̅ᵢ)². At 1855, collaborative utility 150 can add the square of the difference between the second rating V_{i,j} and the average rating for the other user Uᵢ, calculated at 1850, to the third variable.

At 1860, collaborative utility 150 can determine whether or not another item can be processed in calculating the correlation coefficient. For example, method elements 1820-1855 can be performed for each item in a set B, where B is a set of indexes corresponding to items that both Uₐ and Uᵢ have rated. If another item can be processed in calculating the correlation coefficient, the method can proceed to 1820. If another item is not to be processed in calculating the correlation coefficient, collaborative utility 150 can calculate a multiplicative product of the second variable and the third variable at 1865.

At 1870, collaborative utility 150 can calculate a square root of the multiplicative product of the second variable and the third variable. At 1875, collaborative utility 150 can calculate a quotient of the first variable and the square root of the multiplicative product of the second variable and the third variable, where the first variable is the dividend and the square root of the multiplicative product of the second variable and the third variable is the divisor. In one or more embodiments, the quotient is the correlation coefficient calculated by the method illustrated in FIGS. 18A and 18B. For example, the method illustrated in FIGS. 18A and 18B can calculate the correlation coefficient w(a, i) of equation 2305 of FIG. 23.

In one or more embodiments, the correlation coefficient calculated using the method illustrated in FIGS. 18A and 18B can be or include a measure of a correlation or linear independence between two users' ratings of items giving a value between −1 and +1 inclusive. For example, if the users' overall ratings are similar or correlated, the ratings are considered linear dependent; otherwise, the ratings are considered linearly independent. In one or more embodiments, the correlation coefficient between two variables (e.g., vectors (V_{a,1}, . . . , V_{a,N}) and (V_{i,1}, . . . , V_{i,N})) can be defined as the covariance of the two variables divided by the product of their standard deviations. In one example, a correlation coefficient value of 1 implies that a linear equation describes the relationship between two user/item vectors, with all data points lying on a line. In a second example, a correlation coefficient value of −1 implies that all data points lie on a line for which one vector increases as the other decreases. In another example, a correlation coefficient value of 0 implies that there is no linear correlation between the two variables.

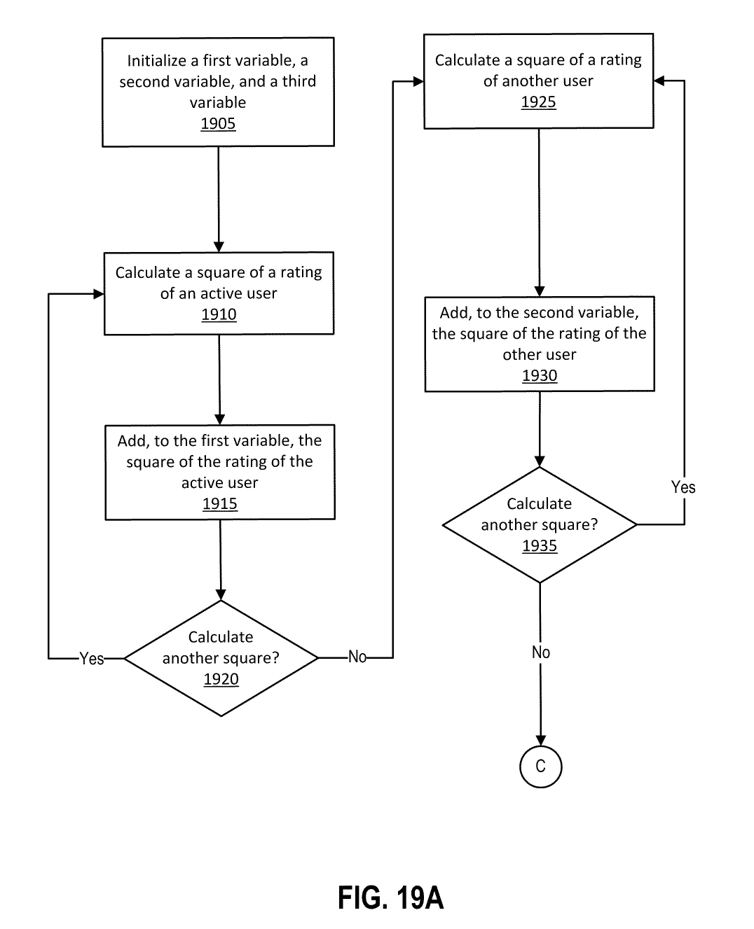

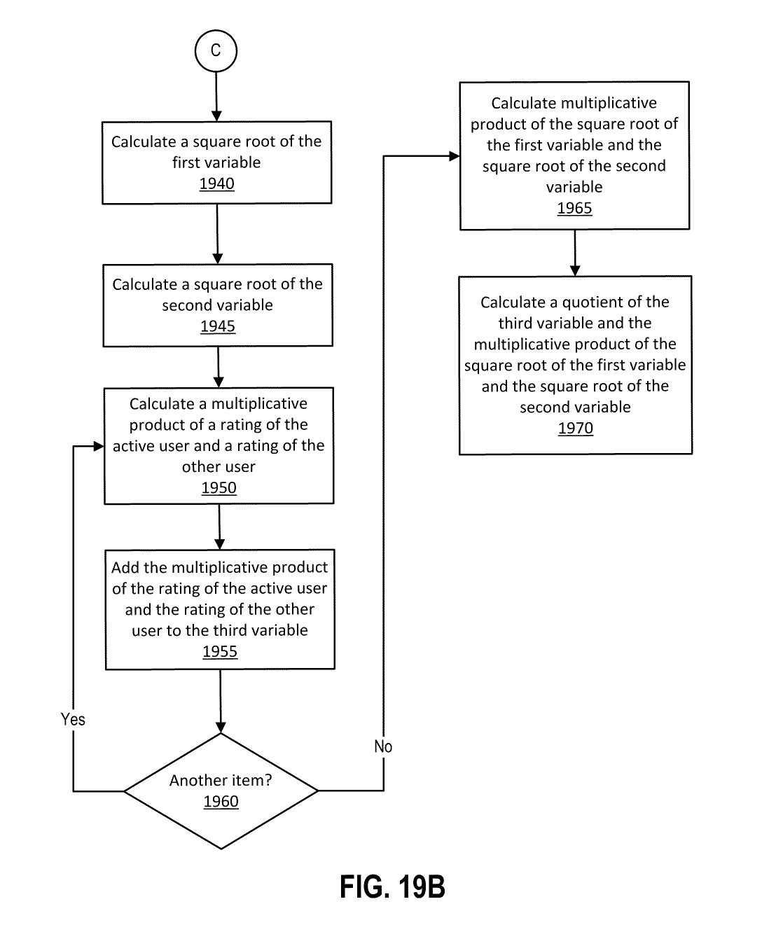

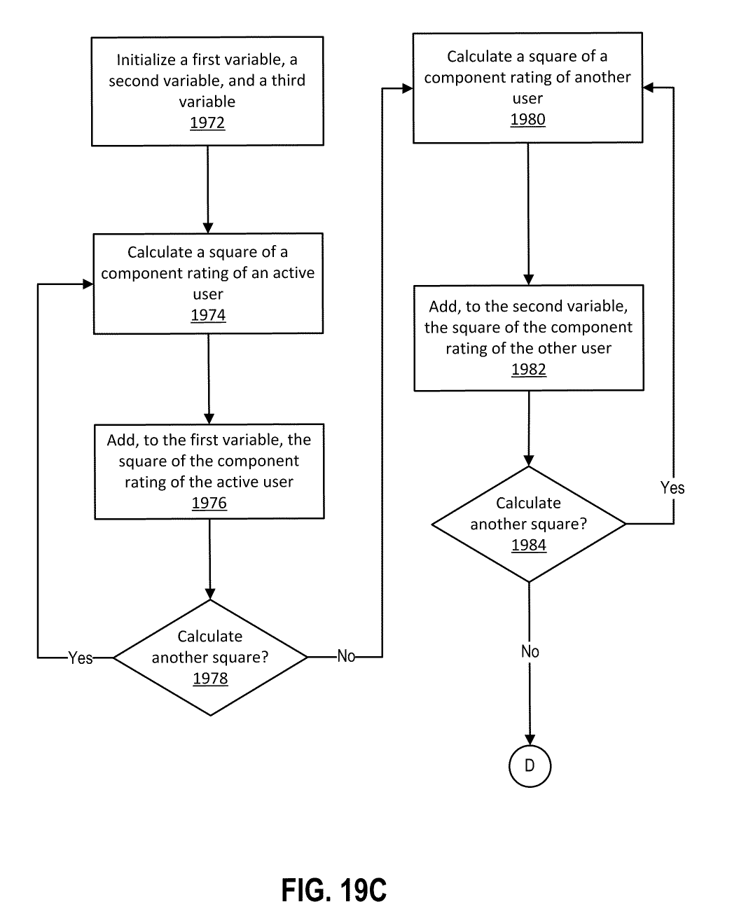

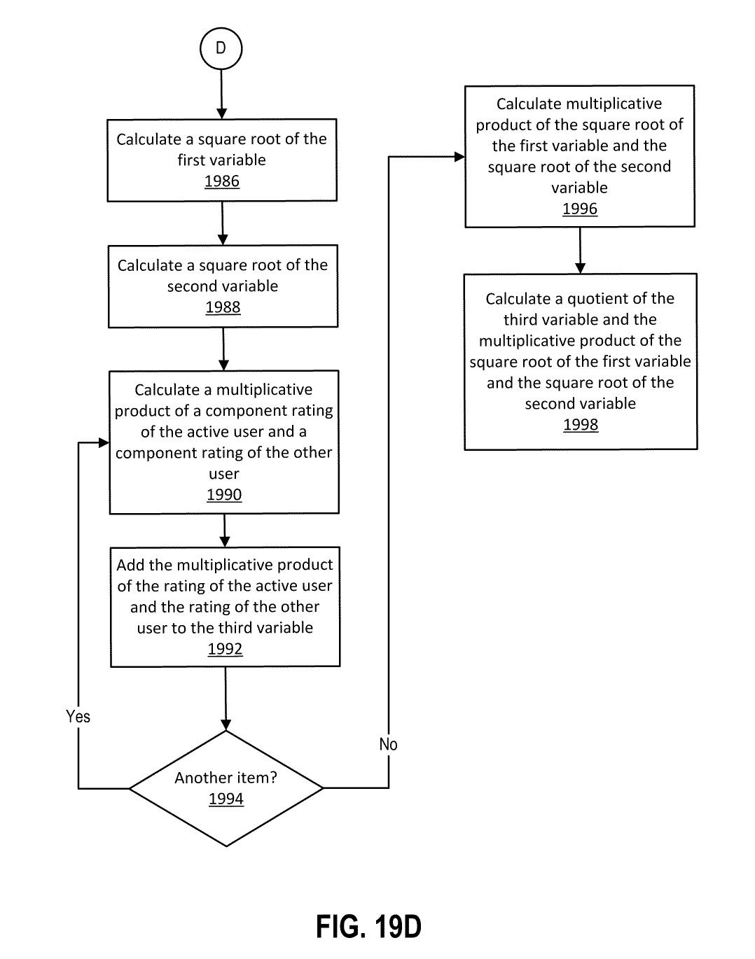

Turning now to FIGS. 19A and 19B, a method of calculating a correlation coefficient is illustrated, according to one or more embodiments. At 1905, collaborative utility 150 can initialize a first variable, a second variable, and a third variable to zero. In one or more embodiments, each of the first variable, the second variable, and the third variable can be used to store a sum of numbers. At 1910, collaborative utility 150 can calculate a square of a rating on an active user Uₐ (i.e., V_{a,k}² for an item index k). At 1915, collaborative utility 150 can add the square of the rating on the active user Uₐ, calculated at 1910, to the first variable. At 1920, collaborative utility 150 can determine whether or not to calculate another square for another rating of the active user Uₐ. In one example, method elements 1910 and 1915 can be performed for each item in the set {I₁, . . . , I_{N}}. For instance, k can be a running index in performing method elements 1910 and 1915, where k can iterate over 1 . . . N.

If another square for another rating of the active user Uₐ can be calculated, the method can proceed to 1910. If another square for another rating of the active user Uₐ is not to be calculated, collaborative utility 150 can calculate a square of a rating on another user Uᵢ(i.e., V_{i,k}² for an item index k) at 1925. At 1930, collaborative utility 150 can add the square of the rating on the other user Uᵢ, calculated at 1925, to the second variable.

At 1935, collaborative utility 150 can determine whether or not to calculate another square for another rating of the other user Uᵢ. For example, method elements 1925 and 1930 can be performed for each item in the set {I₁, . . . , I_{N}}. For instance, k can be a running index in performing method elements 1925 and 1930, where k can iterate over 1 . . . N. If another square for another rating of the other user Uᵢ can be calculated, the method can proceed to 1925. If another square for another rating of the other user Uᵢ is not to be calculated, collaborative utility 150 can calculate a square root of the first variable at 1940. At 1945, collaborative utility 150 can calculate a square root of the second variable.

At 1950, collaborative utility 150 can calculate a multiplicative product of a rating of the active user Uₐ and a rating of the other user Uᵢ. At 1955, collaborative utility 150 can add the multiplicative product of the rating of the active user Uₐ and the rating of the other user Uᵢ to the third variable. At 1960, collaborative utility 150 can determine whether or not to process additional ratings. For example, method elements 1950 and 1955 can be performed where j can be a running index and where j can iterate over 1 . . . N. If additional ratings are to be processed, the method can proceed to 1950. If additional ratings are not to be processed, collaborative utility 150 can, at 1965, calculate a multiplicative product of the square root of the first variable and the square root of the second variable. At 1970, collaborative utility 150 can calculate a quotient of the third variable and the multiplicative product of the square root of the first variable and the square root of the second variable, where the dividend is the third variable and the multiplicative product of the square root of the first variable and the square root of the second variable is the divisor. The quotient calculated at 1970 is the correlation coefficient. In one or more embodiments, the method illustrated in FIGS. 19A and 19B can calculate the correlation coefficient w(a, i) of equation 2310 of FIG. 23.

In one or more embodiments, the correlation coefficient calculated via the method illustrated in FIGS. 19A and 19B can be or include a similarity or distance function. For example, the correlation coefficient calculated via the method illustrated in FIGS. 19A and 19B can be utilized as a cosine of an angle between two user vectors of matrix 1510 (e.g., vectors (V_{a,1}, . . . , V_{a,N}) for an active user Uₐ and (V_{i,1}, . . . , V_{i,N}) for another user Uᵢ). For instance, as the angle between the user vectors shortens, the cosine angle approaches one. This can indicate that the user vectors are becoming “closer” and similarity of the users corresponding to the two user vectors can increase. In one or more embodiments, the data can be centered (e.g., when the data have been shifted by a sample mean so as to have an average of zero) as a result of the correlation coefficient calculated via the method illustrated in FIGS. 19A and 19B (the same as the correlation coefficient calculated via the method illustrated in FIGS. 18A and 18B).

Turning now to FIGS. 19C and 19D, a method of calculating a correlation coefficient is illustrated, according to one or more embodiments. The correlation coefficient calculated via the method illustrated in FIGS. 19C and 19D can be similar to the method illustrated in FIGS. 19A and 19B by including component ratings of patterns. At 1972, collaborative utility 150 can initialize a first variable, a second variable, and a third variable to zero. In one or more embodiments, each of the first variable, the second variable, and the third variable can be used to store a sum of numbers. At 1974, collaborative utility 150 can calculate a square of a component rating on an active user Uₐ (i.e., CV_{a,k}² for component index k). At 1976, collaborative utility 150 can add the square of the component rating on the active user Uₐ, calculated at 1974, to the first variable. At 1978, collaborative utility 150 can determine whether or not to calculate another square for another component rating of the active user Uₐ. In one example, method elements 1974 and 1976 can be performed for each component rating in the set {CV_{a,1}, . . . , CV_{a,P·N}}. For instance, k can be a running index in performing method elements 1910 and 1915, where k can iterate over 1 . . . P·N.

If another square for another component rating of the active user Uₐ can be calculated, the method can proceed to 1974. If another square for another component rating of the active user Uₐ is not to be calculated, collaborative utility 150 can calculate a square of a component rating on another user U, (i.e., CV_{a,k}² for an item index k) at 1980. At 1982, collaborative utility 150 can add the square of the component rating on the other user Uᵢ calculated at 1925, to the second variable.

At 1984, collaborative utility 150 can determine whether or not to calculate another square for another component rating of the other user U₁. For example, method elements 1980 and 1982 can be performed for each component rating in the set {CV_{i,1}, . . . , CV_{i,P·N}}. For instance, k can be a running index in performing method elements 1980 and 1982, where k can iterate over 1 . . . P·N. If another square for another rating of the other user Uᵢ can be calculated, the method can proceed to 1980. If another square for another rating of the other user Uᵢ is not to be calculated, collaborative utility 150 can calculate a square root of the first variable at 1986. At 1988, collaborative utility 150 can calculate a square root of the second variable.

At 1990, collaborative utility 150 can calculate a multiplicative product of a component rating of the active user Uₐ and a component rating of the other user Uᵢ. At 1992, collaborative utility 150 can add the multiplicative product of the component rating of the active user Uₐ and the component rating of the other user Uᵢ to the third variable. At 1994, collaborative utility 150 can determine whether or not to process additional component ratings. For example, method elements 1990 and 1992 can be performed where j can be a running index and where j can iterate over 1 . . . P·N. If additional ratings are to be processed, the method can proceed to 1990. If additional ratings are not to be processed, collaborative utility 150 can, at 1996, calculate a multiplicative product of the square root of the first variable and the square root of the second variable. At 1998, collaborative utility 150 can calculate a quotient of the third variable and the multiplicative product of the square root of the first variable and the square root of the second variable, where the dividend is the third variable and the multiplicative product of the square root of the first variable and the square root of the second variable is the divisor. The quotient calculated at 1970 is the correlation coefficient. In one or more embodiments, the method illustrated in FIGS. 19C and 19D can calculate the correlation coefficient w(a, i) of equation 2410 of FIG. 24.

Turning now to FIG. 20, a method of calculating a correlation coefficient is illustrated, according to one or more embodiments. At 2005, collaborative utility 150 can determine one or more neighbors (e.g., users) of an active user Uₐ. In one or more embodiments, determining one or more neighbors of an active user Uₐ can include determining one or more rating vectors of other users that can be considered “neighbors” of the active user Uₐ.

For example, a measure can be used in determining the one or more rating vectors of other users that can be considered “neighbors” of the active user Uₐ, and the one or more rating vectors of other users that are within a value “k” of the measure can be considered “neighbors” of the active user Uₐ. In one instance, the measure can include an Euclidean distance, and the one or more rating vectors of other users that are within a distance “k” of the active user Uₐ can be considered “neighbors” of the active user Uₐ. In another instance, the measure can include a Hamming distance, and the one or more rating vectors of other users that are within “k” vector element substitutions of the active user Uₐ can be considered “neighbors” of the active user Uₐ.

At 2010, collaborative utility 150 can determine whether or not another user is a neighbor of the active user Uₐ. If the other user is a neighbor of the active user Uₐ, collaborative utility 150 can indicate one as the value of the correlation coefficient at 2015. If the other user is not a neighbor of the active user Uₐ, collaborative utility 150 can indicate zero as the value of the correlation coefficient at 2020. In one or more embodiments, the method illustrated in FIG. 20 can calculate the correlation coefficient w(a, i) of equation 2315 of FIG. 23.

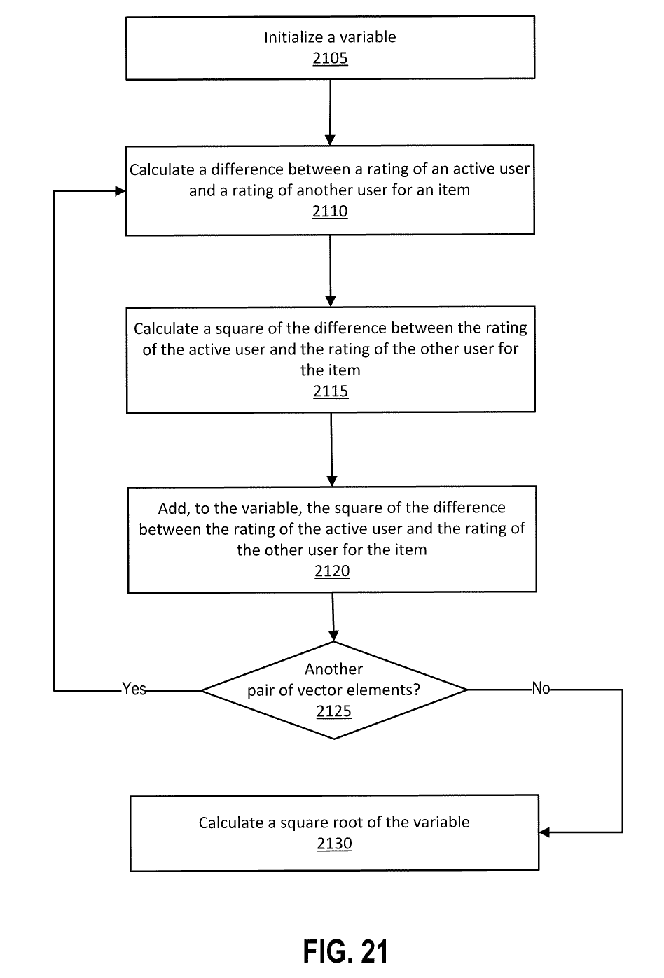

Turning now to FIG. 21, a method of calculating an Euclidean distance is illustrated, according to one or more embodiments. At 2105, collaborative utility 150 can initialize a variable. In one or more embodiments, the variable can store a sum of numbers. At 2110, collaborative utility 150 can calculate a difference between a rating V_{a,j} of an active user Uₐ for an item j and a rating of V_{i,j} of another user Uᵢ for the item index j. For example, (V_{a,j}−V_{i,j}) can be calculated at 2110. At 2115, collaborative utility 150 calculate a square of the difference between the rating V_{a,j} of the active user Uₐ for the item index j and the rating of V_{i,j} of the other user Uᵢ for the item index j. For example, (V_{a,j}−V_{i,j})² can be calculated at 2115. At 2120, collaborative utility 150 can add the square of the difference between the rating V_{a,j} of the active user Uₐ for the item index j and the rating of V_{i,j} of the other user U, for the item index j, calculated at 2115, to the variable.

At 2125, collaborative utility 150 can determine whether or not another pair of vector elements can be processed. For example, method elements 2110-2120 can be performed for each corresponding pair of vector elements in vectors (V_{a,1}, . . . , V_{a,N}) and (V_{i,1}, . . . , V_{i,N}). For instance, j can be a running index in performing method elements 2110-2120, where j can iterate over 1 . . . N. In one or more embodiments, if an item has not been rated by a user, a median value (e.g., three on a scale from one to five) can be used for the user's rating of the item.

If another pair of vector elements can be processed, the method can proceed to 2110. If another pair of vector elements is not to be processed, collaborative utility 150 calculate a square root of the variable. In one or more embodiments, the square root of the variable is an Euclidean distance between ratings of the active user Uₐ and the other user Uᵢ. In one or more embodiments, the method illustrated in FIG. 21 can calculate the distance d(\check{V}ₐ, \check{V}ᵢ) of equation 2215 of FIG. 22.

In one or more embodiments, one or more of the method elements described and/or one or more portions of an implementation of a method element can be performed in varying orders, can be performed concurrently with one or more of the other method elements and/or one or more portions of an implementation of a method element, or can be omitted. Utilization of a particular sequence is therefore, not to be taken in a limiting sense, and the scope of the present invention is defined only by the appended claims.

Additional method elements can be performed as desired. In one or more embodiments, concurrently can mean simultaneously. In one or more embodiments, concurrently can mean apparently simultaneous according to some metric. For example, two or more method elements and/or two or more portions of an implementation of a method element can be performed such that they appear to be simultaneous to a human. In one or more embodiments, one or more of the system elements described herein may be omitted and additional system elements may be added as desired.

The processes and/or methods in the described embodiments can be implemented using any combination of software, firmware, and/or hardware. As a preparatory step to practicing the described embodiments in software, the processor programming code (whether software or firmware) can be stored in one or more machine readable storage mediums such as fixed (hard) drives, diskettes, optical disks, magnetic tape, semiconductor memories such as ROMs, PROMs, etc., thereby making an article of manufacture in accordance with one or more embodiments. An article of manufacture including the programming code can be utilized by either executing the code directly from the storage device, by copying the code from the storage device into another storage device such as a hard disk, RAM, etc. One or more method and/or process embodiments can be practiced by combining one or more machine-readable storage devices containing the code with appropriate processing hardware to execute the code included therein. An apparatus for practicing the one or more embodiments described could be one or more processing devices and storage systems containing or having network access to program(s) coded.

Those skilled in the art will appreciate that the software aspects of one or more embodiments are capable of being distributed as a program product in a variety of forms, and that the one or more embodiments described can apply equally regardless of the particular type of signal bearing media used to actually carry out the distribution. Examples of signal bearing media include recordable type media such as floppy disks, hard disk drives, CD ROMs, and transmission type media such as digital and analogue communication links. It will be understood by those skilled in the art that various changes in form and detail may be made therein without departing from the spirit and scope of the invention as defined by the appended claims.

What is claimed is:

1. A method, comprising:
receiving network event data;
determining a network pattern from the network event data;
determining a plurality of network patterns based on a plurality of components of the network pattern, wherein each of the plurality of network patterns includes the plurality of components of the network pattern;
accessing a data structure that includes a plurality of vectors corresponding to a plurality of users, wherein each vector of the plurality of vectors includes a plurality of ratings corresponding to the plurality of network patterns;
calculating, based on the plurality of ratings, a plurality of predictive ratings corresponding to the plurality of network patterns;
ranking the plurality of network patterns based on the plurality of predictive ratings; and
after said ranking, recommending at least a first ranked network pattern of the plurality of network patterns.

2. The method of claim 1,
wherein the plurality of vectors is a plurality of arrays of elements corresponding to the plurality of users; and
wherein each array of elements of the plurality of arrays of elements includes the plurality of ratings corresponding to the plurality of network patterns.

3. The method of claim 1, wherein the plurality of ratings corresponding to the plurality of network patterns includes a plurality of component ratings corresponding to at least one of the plurality of components of the network pattern.

4. The method of claim 1, wherein one or more of the plurality of components of the network pattern include respective one or more of a source Internet protocol (IP) address, a destination IP address, a source media access control (MAC) address, a destination MAC address, a source port number, a destination port number, a protocol, an ingress interface identification, a type of service identification, a packet length, and a sequence number.

5. The method of claim 1,
wherein at least two of the plurality of users are included in a community of users;
wherein said calculating, based on the plurality of ratings, the plurality of predictive ratings corresponding to the plurality of network patterns is further based on a vector of the plurality of vectors corresponding to a user of the plurality of users; and
wherein the user is included in the community of users.

6. The method of claim 5, wherein the community of users includes a plurality of network analysts.

7. The method of claim 1, wherein said accessing the data structure includes indexing into the data structure utilizing at least one index to access at least one rating of the plurality of ratings.

8. The method of claim 7, wherein the least one index include a memory offset, a row of a table of a database, or a column of the table of the database.

9. The method of claim 1, further comprising:
initiating graph pattern matching within an input graph that represents a social network, the graph pattern matching utilizing pre-defined social network analysis metrics to provide a context for finding a true match, wherein the graph pattern matching locates one or more matched graphs within the input graph including similar inter-connections among nodes as a target graph pattern; and
analyzing each matched graph of the one or more matched graphs using social network analysis metrics-based context from at least one of local node attributes within the matched graph and non-local node attributes, external to the matched graph, to determine when the matched graph is a true match;
wherein the network pattern is included in the one or more matched graphs and is a true match.

10. The method of claim 1,
wherein said calculating, based on the plurality of ratings, the plurality of predictive ratings corresponding to the plurality of network patterns includes calculating a plurality of correlation coefficients; and
wherein calculating each predictive rating of the plurality of predictive ratings includes summing a plurality of products, wherein each product of the plurality of products is produced from a plurality of factors, wherein a first factor of the plurality of factors is a correlation coefficient of the plurality of correlation coefficients.

11. The method of claim 10, wherein a second factor of the plurality of factors is a rating of the plurality of ratings less an average rating for a user of the plurality of users.

12. The method of claim 1,
wherein said calculating, based on the plurality of ratings, the plurality of predictive ratings corresponding to the plurality of network patterns includes calculating a plurality of correlation coefficients; and
wherein said calculating the plurality of correlation coefficients includes:
calculating a first sum of first values, wherein each of the first values includes a first rating of the plurality of ratings corresponding to a user of the plurality of users and a first network pattern of the plurality of network patterns; and
calculating a second sum of second values, wherein each of the second values includes a second rating of the plurality of ratings corresponding to another user of the plurality of users and the first network pattern of the plurality of network patterns.

13. The method of claim 12, wherein said calculating, based on the vector of the plurality of vectors corresponding to the user of the plurality of users and the plurality of vectors, the plurality of correlation coefficients includes:
calculating a quotient, wherein the quotient includes a dividend that is based on the first sum of the first values and the second sum of the second values.

14. The method of claim 1,
wherein said ranking the plurality of network patterns based on the plurality of predictive ratings includes:
sorting the plurality of predictive ratings from a high predictive rating of the plurality of predictive ratings to a low predictive rating of the plurality of predictive ratings; and
ordering the plurality of patterns based on the plurality of predictive ratings sorted from the high predictive rating of the plurality of predictive ratings to the low predictive rating of the plurality of predictive ratings; and
wherein the at least the first ranked network pattern corresponds to the high predictive rating.

15. The method of claim 1, wherein the plurality of network patterns includes a plurality of computer network events.

16. The method of claim 1, wherein the plurality of network patterns includes a plurality of graph matched patterns.

17. The method of claim 1, further comprising:
displaying the at least the first ranked network pattern.

18. The method of claim 1, wherein the plurality of network patterns includes a plurality of cyber threat patterns.

19. A computer program product, comprising:
a computer readable memory medium; and
program code on the computer readable memory medium that when executed by a data processing system, cause the data processing system to perform:
receiving network event data;
determining a network pattern from the network event data;
determining a plurality of network patterns based on a plurality of components of the network pattern, wherein each of the plurality of network patterns includes the plurality of components of the network pattern;
accessing a data structure that includes a plurality of vectors corresponding to a plurality of users, wherein each vector of the plurality of vectors includes a plurality of ratings corresponding to the plurality of network patterns;
calculating, based on the plurality of ratings, a plurality of predictive ratings corresponding to the plurality of network patterns;
ranking the plurality of network patterns based on the plurality of predictive ratings; and
after said ranking, recommending at least a first ranked network pattern of the plurality of network patterns.

20. The computer program product of claim 19,
wherein the plurality of vectors is a plurality of arrays of elements corresponding to the plurality of users; and
wherein each array of elements of the plurality of arrays of elements includes the plurality of ratings corresponding to the plurality of network patterns.

21. The computer program product of claim 19, wherein the plurality of ratings corresponding to the plurality of network patterns includes a plurality of component ratings corresponding to at least one of the plurality of components of the network pattern.

22. The computer program product of claim 19, wherein one or more of the plurality of components of the network pattern include respective one or more of a source Internet protocol (IP) address, a destination IP address, a source media access control (MAC) address, a destination MAC address, a source port number, a destination port number, a protocol, an ingress interface identification, a type of service identification, a packet length, and a sequence number.

23. The computer program product of claim 19,
wherein at least two of the plurality of users are included in a community of users;
wherein said calculating, based on the plurality of ratings, the plurality of predictive ratings corresponding to the plurality of network patterns is further based on a vector of the plurality of vectors corresponding to a user of the plurality of users; and
wherein the user is included in the community of users.

24. The computer program product of claim 23, wherein the community of users includes a plurality of network analysts.

25. The computer program product of claim 19, wherein said accessing the data structure includes indexing into the data structure utilizing at least one index to access at least one rating of the plurality of ratings.

26. The computer program product of claim 25, wherein the least one index include a memory offset, a row of a table of a database, or a column of the table of the database.

27. The computer program product of claim 19, wherein the program code on the computer readable memory medium that when executed by the data processing system, cause the data processing system to further perform:
initiating graph pattern matching within an input graph that represents a social network, the graph pattern matching utilizing pre-defined social network analysis metrics to provide a context for finding a true match, wherein the graph pattern matching locates one or more matched graphs within the input graph including similar inter-connections among nodes as a target graph pattern; and
analyzing each matched graph of the one or more matched graphs using social network analysis metrics-based context from at least one of local node attributes within the matched graph and non-local node attributes, external to the matched graph, to determine when the matched graph is a true match;
wherein the network pattern is included in the one or more matched graphs and is a true match.

28. The computer program product of claim 19,
wherein said calculating, based on the plurality of ratings, the plurality of predictive ratings corresponding to the plurality of network patterns includes calculating a plurality of correlation coefficients; and
wherein calculating each predictive rating of the plurality of predictive ratings includes summing a plurality of products, wherein each product of the plurality of products is produced from a plurality of factors, wherein a first factor of the plurality of factors is a correlation coefficient of the plurality of correlation coefficients.

29. The computer program product of claim 28, wherein a second factor of the plurality of factors is a rating of the plurality of ratings less an average rating for a user of the plurality of users.

30. The computer program product of claim 19,
wherein said calculating, based on the plurality of ratings, the plurality of predictive ratings corresponding to the plurality of network patterns includes calculating a plurality of correlation coefficients; and
wherein said calculating the plurality of correlation coefficients includes:
calculating a first sum of first values, wherein each of the first values includes a first rating of the plurality of ratings corresponding to a user of the plurality of users and a first network pattern of the plurality of network patterns; and
calculating a second sum of second values, wherein each of the second values includes a second rating of the plurality of ratings corresponding to another user of the plurality of users and the first network pattern of the plurality of network patterns.

31. The computer program product of claim 30, wherein said calculating, based on the vector of the plurality of vectors corresponding to the user of the plurality of users and the plurality of vectors, the plurality of correlation coefficients includes:
calculating a quotient, wherein the quotient includes a dividend that is based on the first sum of the first values and the second sum of the second values.

32. The computer program product of claim 19,
wherein said ranking the plurality of network patterns based on the plurality of predictive ratings includes:
sorting the plurality of predictive ratings from a high predictive rating of the plurality of predictive ratings to a low predictive rating of the plurality of predictive ratings; and
ordering the plurality of patterns based on the plurality of predictive ratings sorted from the high predictive rating of the plurality of predictive ratings to the low predictive rating of the plurality of predictive ratings; and
wherein the at least the first ranked network pattern corresponds to the high predictive rating.

33. The computer program product of claim 19, wherein the plurality of network patterns includes a plurality of computer network events.

34. The computer program product of claim 19, wherein the plurality of network patterns includes a plurality of graph matched patterns.

35. The computer program product of claim 19, wherein the program code on the computer readable memory medium that when executed by the data processing system, cause the data processing system to further perform:
displaying the at least the first ranked network pattern.

36. The computer program product of claim 19, wherein the plurality of network patterns includes a plurality of cyber threat patterns.

37. A system, comprising:
a memory including program instructions; and
a processor coupled to the memory;
wherein the processor fetches the program instructions from the memory; and
wherein, based on the program instructions fetched from the memory, the processor:
receives network event data;
determines a network pattern from the network event data;
determines a plurality of network patterns based on a plurality of components of the network pattern, wherein each of the plurality of network patterns includes the plurality of components of the network pattern;
accesses a data structure that includes a plurality of vectors corresponding to a plurality of users, wherein each vector of the plurality of vectors includes a plurality of ratings corresponding to the plurality of network patterns;
calculates, based on the plurality of ratings, a plurality of predictive ratings corresponding to the plurality of network patterns;
ranks the plurality of network patterns based on the plurality of predictive ratings; and
after ranking the plurality of network patterns based on the plurality of predictive ratings, recommends at least a first ranked network pattern of the plurality of network patterns.

38. The system of claim 37, wherein when the processor accesses the data structure, the processor indexes into the data structure utilizing at least one index to access at least one rating of the plurality of ratings.

39. The system of claim 37, wherein, based on the program instructions fetched from the memory, the processor:
initiates graph pattern matching within an input graph that represents a social network, the graph pattern matching utilizing pre-defined social network analysis metrics to provide a context for finding a true match, wherein the graph pattern matching locates one or more matched graphs within the input graph including similar inter-connections among nodes as a target graph pattern; and
analyzes each matched graph of the one or more matched graphs using social network analysis metrics-based context from at least one of local node attributes within the matched graph and non-local node attributes, external to the matched graph, to determine when the matched graph is a true match;
wherein the network pattern is included in the one or more matched graphs and is a true match.

40. The system of claim 37, further comprising:
a display coupled to the processor;
wherein, based on the program instructions fetched from the memory, the processor, via the display, displays the at least the first ranked network pattern.

41. The system of claim 37,
wherein the processor includes at least one of an arithmetic logic unit and a floating-point unit;
wherein when the processor calculates, based on the plurality of ratings, the plurality of predictive ratings corresponding to the plurality of network patterns, the processor configures the at least one of the arithmetic logic unit and the floating-point unit and the east one of the arithmetic logic unit and the floating-point unit calculates, based on the plurality of ratings, the plurality of predictive ratings corresponding to the plurality of network patterns.

42. The system of claim 37, further comprising:
a router coupled to the processor;
wherein when the processor receives the network event data, the processor receives the network event data from the router.
